(19) United States
(12) Patent Application Publication
(10) Pub. No.: US 2024/0047157 A1
(43) Pub. Date: Feb. 8, 2024

(54) Smart Mounting System for a Remote Control Device

(71) Applicant: Lutron Technology Company LLC, Coopersburg, PA (US)

(72) Inventors: Chris Dimberg, Easton, PA (US); Matthew V. Harte, Stewartsville, NJ (US); Matthew P. McDonald, Phoenixville, PA (US); Robert C. Newman, Jr., Emmaus, PA (US); Daniel L. Twaddell, Bethlehem, PA (US)

(73) Assignee: Lutron Technology Company LLC, Coopersburg, PA (US)

(21) Appl. No.: 18/258,822

(22) PCT Filed: Dec. 21, 2021
(86) PCT No.: PCT/US2021/064703

§ 371 Date: Jun. 22, 2023

(51) Int. Cl. H01H 19/14; H01H 9/02; G08C 17/02

(52) U.S. Cl. CPC H01H 19/14; H01H 9/0235; G08C 17/02; G08C 2201/10; G08C 2201/32; G08C 2201/34; H01H 2300/03

(57) ABSTRACT

A remote control device my comprise a control unit and a mounting structure (e.g., a smart mounting structure) to which the control unit is configured to be mounted. The control unit may be configured to operate in a plurality of operating modes. The control unit may transmit a first message for controlling a first electrical load when the control unit is operating in a first operating mode and a second message for controlling a second electrical load when the control unit is operating in a second operating mode. When the control unit is mounted to the mounting unit, the mounting unit may transmit a third message to the first control circuit of the control unit in response to receiving a user input received via an input circuit of the control unit. The control unit may change between the plurality of operating modes in response to receiving the third message.

### BACKGROUND

A user environment, such as a residence or an office building for example, may be configured using various types of load control systems. A lighting control system may be used to control the lighting loads in the user environment. A motorized window treatment control system may be used to control the natural light provided to the user environment. A heating, ventilation, and cooling (HVAC) system may be used to control the temperature in the user environment. Each load control system may include various control devices, including control-source devices and control-target devices. The control-target devices may receive messages (e.g., digital messages), which may include load control instructions, for controlling an electrical load from one or more of the control-source devices. The control-target devices may be capable of directly controlling an electrical load. The control-source devices may be capable of indirectly controlling the electrical load via the control-target device. Examples of control-target devices may include lighting control devices (e.g., a dimmer switch, an electronic switch, a ballast, or a light-emitting diode (LED) driver), a motorized window treatment, a temperature control device (e.g., a thermostat), an plug-in load control device, and/or the like. Examples of control-source devices may include remote control devices, occupancy sensors, daylight sensors, temperature sensors, and/or the like.

### SUMMARY

As described herein, a remote control device my comprise a control unit and a mounting structure (e.g., a smart mounting structure) to which the control unit is configured to be mounted. The control unit may comprise a first input circuit configured to receive user inputs, a first wireless communication circuit configured to transmit and receive wireless signals via a wireless communication link, and a first control circuit configured to cause the first wireless network communication circuit to transmit messages via the wireless signals in response to the user inputs received via the input circuit. The first control circuit may be configured to operate in a plurality of operating modes. The first control circuit may be configured to transmit a first message for controlling a first electrical load when the control unit is operating in a first operating mode of the plurality of operating modes and a second message for controlling a second electrical load when the control unit is operating in a second operating mode of the plurality of operating modes. The mounting unit may comprise a second input circuit configured to receive user inputs and a second control circuit responsive to the second input circuit of the mounting unit. When the control unit is mounted to the mounting unit, the second control circuit of the mounting unit may be configured to transmit a third message to the first control circuit of the control unit in response to receiving a user input via the second input circuit, and the first control circuit of the control unit may be configured to change between the plurality of operating modes in response to receiving the third message from the second control circuit of the mounting unit.

In addition, the second control circuit of the mounting unit may be configured to determine a selected preset for controlling one or more electrical loads in response to receiving a user input via the second input circuit and transmit a first message including the selected preset to the first control circuit of the control unit when the control unit is mounted to the mounting unit. When the control unit is mounted to the mounting unit, the second control circuit of the mounting unit is configured to determine a selected preset for controlling one or more electrical loads in response to receiving a user input via the second input circuit and transmit a first message including the selected preset to the first control circuit of the control unit, the first control circuit of the control unit is configured to receive the first message from the second control circuit of the mounting unit and transmit a second message including the selected preset via the wireless communication circuit.

### BRIEF DESCRIPTION OF THE DRAWINGS

FIG. 1 is a simplified diagram of an example load control system that includes an example retrofit remote control device.

FIG. 2 is a front perspective view of an example remote control device (e.g., a wall-mounted remote control device) that includes a control unit and a mounting assembly.

FIG. 3 is a perspective view of the remote control device of FIG. 2 with the control unit detached from a base, which is attached to the mounting structure.

FIG. 4 is a rear perspective view of the control unit of FIG. 2 when detached from the base.

FIG. 5 is an exploded view of the remote control device of FIG. 2.

FIG. 6 is a front perspective view of an example remote control device (e.g., a retrofit remote control device) that includes a control unit and a mounting structure.

FIG. 7 is a perspective view of the remote control device of FIG. 6 with a cover portion detached from a mounting frame of the mounting structure.

FIG. 8 is a rear perspective view of the cover portion of FIG. 7.

FIG. 9 is an exploded view of the remote control device of FIG. 6.

FIG. 10 is a front perspective view of an example remote control device (e.g., a tabletop remote control device) that includes a control unit and a pedestal.

FIG. 11 is a perspective view of the remote control device of FIG. 10 with the control unit detached from a base, which is attached to the pedestal.

FIG. 12 is a perspective view of the pedestal of FIG. 10 with the base removed.

FIG. 13 is a side cross-sectional view of the remote control device of FIG. 10 taken through the center of the pedestal.

FIG. 14 is a perspective view of another pedestal to which the control unit and the base of FIG. 11 may be mounted.

FIG. 15 is a front perspective view of an example remote control device (e.g., a tabletop remote control device) that includes a control unit and a pedestal.

FIG. 16 is a rear perspective view of the control unit of FIG. 15 detached from the pedestal.

FIG. 17 is a perspective view of the pedestal of FIG. 15 with the control unit removed.

FIG. 18 is a simplified block diagram of an example control device (e.g, a remote control device).

### DETAILED DESCRIPTION

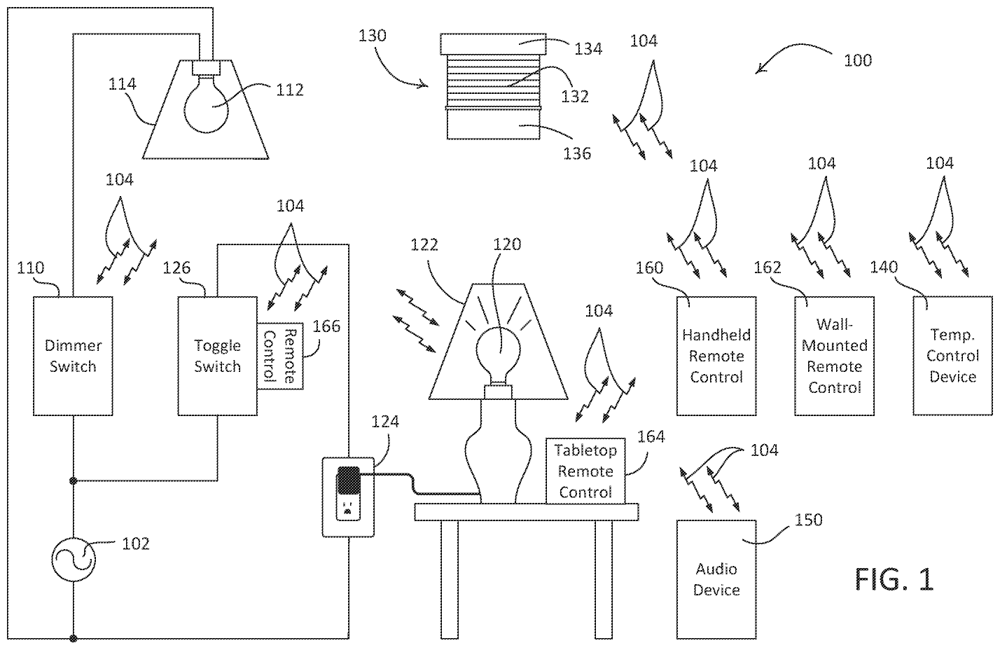

FIG. 1 is a simplified block diagram of an example load control system 100 for controlling one or more electrical devices. The load control system 100 may include one or more load control devices for controlling an amount of power delivered from an alternating-current (AC) power source to one or more electrical loads. For example, the load control system 100 may comprises a dimmer switch 110 configured to control the amount of power delivered to a lighting load 112. As shown in FIG. 1, the lighting load 112 may be installed in a ceiling-mounted downlight fixture 114. The dimmer switch that may be configured to be mounted to a standard electrical wall box and be coupled in series electrical connection between the AC power source 102 and the lighting load 112 for conducting a load current through the lighting load 112. The dimmer switch 110 may receive an AC mains line voltage from the AC power source 102, and may generate a phase-control signal for controlling the lighting load 102. The phase-control signal may be generated via various phase-control techniques (e.g., a forward phase-control dimming technique or a reverse phase-control dimming technique).

The dimmer switch 110 may be configured to control the intensity level and/or the color (e.g., color temperature) of light emitted by the lighting load 112. For example, the dimmer switch 110 may be configured to control the intensity level of the lighting load 112 between a low-end intensity L_{LE} (e.g., approximately 1%) and a high-end intensity L_{HE} (e.g., approximately 100%). The dimmer switch 110 may comprise a user interface for receiving a user input, and may be configured to control the lighting load 112 (e.g., the intensity and/or color of the lighting load) in response to the user input receives via the user interface. The dimmer switch 110 may be also configured to receive messages (e.g., digital messages) via wireless signals, such as radio-frequency (RF) signals 104 from one or more input devices (e.g., as will be explained in greater detail below). The messages may include commands for controlling the lighting load 112. The dimmer switch 110 may be configured to control the lighting load 112 (e.g., the intensity and/or color of the lighting load) in response to the messages in the received RF signals 104. Examples of wall-mounted dimmer switches are described in greater detail in commonly-assigned U.S. Pat. No. 8,664,881, issued Mar. 4, 2014, entitled TWO-WIRE DIMMER SWITCH FOR LOW-POWER LOADS, the entire disclosure of which is hereby incorporated by reference.

The load system control 100 may also comprises a controllable lighting device 120 (e.g., a wirelessly-controllable smart lamp). As shown in FIG. 1, the controllable lighting device 120 may be installed in a table lamp 122 that is plugged into an electrical receptacle 124. The electrical receptable 124 may receive power from the AC power source 102 through an mechanical switch 126 (e.g., a toggle switch and/or a light switch), such that the controllable lighting device 120 may be turned on and off in response to toggling (e.g., closing and opening) of the mechanical switch. The controllable lighting device 120 may be configured to receive messages via the RF signals 104, and control one or more of: the vibrancy, the luminous output, the intensity level, and/or the color (e.g., color temperature and/or color spectrum) of light emitted by controllable lighting device 120 in response to commands included in the received messages. The controllable lighting device 120 may include an internal lighting load (not shown), such as, for example, a light-emitting diode (LED) light engine, a compact fluorescent lamp, an incandescent lamp, a halogen lamp, or other suitable light source. The controllable lighting device 120 may comprise an integral load control circuit (not shown), for controlling the intensity of the lighting load between the low-end intensity L_{LE} and the high-end intensity L_{HE}. The controllable lighting device 120 may comprise a screw-in base (not shown) that is configured to be screwed into a standard Edison socket, such that the controllable light source may be coupled to the AC power source 101.

The load control system 100 may comprise one or more daylight control devices, e.g., a motorized window treatment 130, for controlling the amount of daylight entering a space in which the motorized window treatment is installed. The motorized window treatment 130 may comprise a window treatment fabric 132 hanging from a headrail 134 in front of a window 136. Each motorized window treatment 130 may further comprise a motor drive unit (not shown) located inside of the headrail 134 for raising and lowering the window treatment fabric 132 for controlling the amount of daylight entering the space. The motor drive units of the motorized window treatments 130 may be configured to receive messages via the RF signals 104 and adjust the position of the respective window treatment fabric 132 in response to the received messages. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device.

The load control system 100 may comprise one or more temperature control devices 140, e.g., such as a thermostat, for controlling a temperature (e.g., a room temperature in a room in which the temperature control device 140 is installed). The temperature control device 140 may be coupled to a heating, ventilation, and air conditioning (HVAC) system (not shown) via a control link (e.g., an analog control link or a wired digital communication link). The temperature control device 140 may be configured to wirelessly communicate messages (e.g., digital messages) with a controller of the HVAC system. The temperature control device 140 may comprise a temperature sensor for measuring the room temperature of the room and may control the HVAC system to adjust the temperature in the room to a setpoint temperature. The load control system 100 may comprise one or more wireless temperature sensors (not shown) located in the room for measuring the room temperatures. The HVAC system may be configured to turn a compressor on and off for cooling the room and to turn a heating source on and off for heating the rooms in response to the control signals received from the temperature control device 140. The HVAC system may be configured to turn a fan of the HVAC system on and off in response to the control signals received from the temperature control device 140. The temperature control device 140 and/or the HVAC system may be configured to control one or more controllable dampers to control the air flow in the room. The temperature control device 140 may be configured to receive messages via the RF signals 104 and adjust heating, ventilation, and cooling in response to the received messages.

The load control system 100 may comprise one or more controllable audio devices 150, e.g., such as a speaker having a controllable media player. The audio device 150 may be configured to receive messages via the RF signals 104. The audio device 150 may be configured to raise and lower the volume of the audio device, adjust one or audio output parameters, select one or more audio sources, select one or more audio output devices, play and/or pause playback, and/or skip a track in response to the received messages.

The load control system 100 may comprise one or more input devices. For example, the load control system 100 may comprise one or more remote control devices, such as a handheld remote control device 160, a wall-mounted remote control device 162, a tabletop remote control device 164, and/or a retrofit remote control device 166. Each of the remote control devices may be powered by a direct-current (DC) power source (e.g., a battery or an external DC power supply). Each of the remote control devices may comprise one or more buttons for receiving user inputs. The remote control devices may be configured to transmit messages including commands for controlling the load control devices (e.g., the dimmer switch 110, the controllable lighting device 120, the motorized window treatment 130, the temperature control device 140, and/or the audio device 150) via the RF signals 104. The handheld remote control device 160 may be sized to fit into a user's hand. The wall-mounted remote control device 162 may be mounted to a vertical surface, such as a wall, and/or may be mounted to a standard electrical wall box. The tabletop remote control device 164 may be configured to be placed on a horizontal surface (e.g., a surface of a table).

The retrofit remote control device 166 may be configured to be mounted to a mechanical switch (e.g., a toggle switch 166, a paddle switch, a pushbutton switch, a light switch, or other suitable switch) that may be pre-existing in the load control system 100. Such a retrofit solution may provide energy savings and/or advanced control features, for example without requiring significant electrical re-wiring and/or without requiring the replacement of existing mechanical switches. As an example, a consumer may replace an existing lamp with the controllable lighting device 120, switch the toggle switch 126 that is coupled to the controllable lighting device 120 to the on position, install (e.g., mount) the retrofit remote control device 166 onto the toggle switch 126, and associate the retrofit remote control device 166 with the controllable lighting device 120. The retrofit remote control device 166 may then be used to perform advanced functions that the toggle switch 126 may be incapable of performing (e.g., such as dimming the intensity level of the light output, providing feedback to a user, etc.). As shown, the toggle switch 126 is coupled between the AC power source 102 and the electrical receptacle 124 into which the lamp 122 of the controllable lighting device 120 may be plugged (e.g., as shown in FIG. 1). Alternatively, the toggle switch 126 may be coupled between the AC power source 102 and the controllable lighting device 120 without the electrical receptacle 124.

The input devices of the load control system 100 may also include one or more of an occupancy sensor or a remote vacancy sensor (not shown) for detecting occupancy and/or vacancy conditions in a space surrounding the sensors. The occupancy or vacancy sensors may be configured to transmit messages to the lighting loads 102 (e.g., via the RF signals 104) in response to detecting occupancy or vacancy conditions. The input devices of the load control system 100 may also include a daylight sensor (not shown) for measuring a total light intensity in the space around the daylight sensor. The daylight sensor may be configured to transmit messages, such as a measured light intensity, to the lighting loads 102, 104 such that the lighting loads may be operable to adjust their respective intensities in response to the measured light intensity.

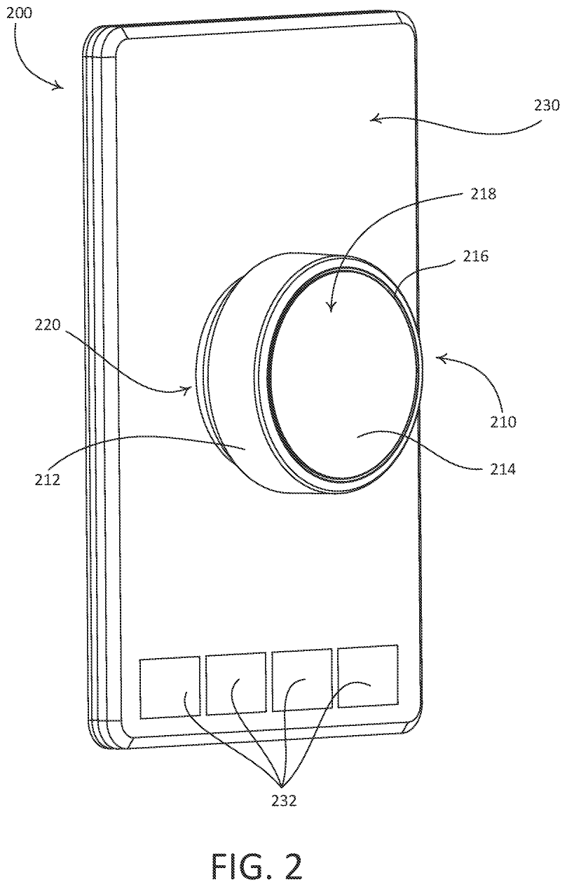

FIG. 2 is a perspective view of an example remote control device 200 (e.g., a battery-powered remote control device) that may be deployed, for example, as the wall-mounted remote control device 162 of the load control system 100 shown in FIG. 1. The remote control device 200 may include a control unit 210 (e.g., a control module) that may be attached to a base 220 (e.g., a base portion and/or a mounting assembly). The base 220 may be mounted to a mounting structure 230, which may be attached to a vertical surface (e.g., a wall). The control unit 210 may include a rotation portion 210 (e.g., an annular rotation portion) that is unidirectionally or bi-directionally rotatable with respect to the base 220 (e.g., configured to rotate about the base 220). The control unit 210 may include an actuation portion 214, which may be operated separately from or in concert with the rotation portion 212. The control unit 210 may be configured to control an electrical load in response to actuations of the rotation portion 212 and/or the actuation portion 214.

The control unit 210 may be configured to provide visible feedback in response to actuations of the rotation portion 212 and/or the actuation portion 214. For example, an upper portion 218 of the actuation portion 214 may be illuminated when the rotation portion 212 and/or the actuation portion 214 is presently being actuated to indicate that the control unit 210 is processing the actuations. The upper portion 218 of the actuation portion 214 may be illuminated from behind by a light source (e.g., an LED) to create a circular glow on the upper portion 218. The control unit 210 may also comprise a visual display, such as a light bar 216, that may be illuminated by one or more light sources (e.g., LEDs) inside of the control unit 210 to provide visible feedback. The light bar 216 may be illuminated to indicate an amount of power being delivered to the electrical load. For example, a portion of the light bar 216 may be illuminated that corresponds to the amount of power being delivered to the electrical load. As the amount of power being delivered to the electrical load increases, the illuminated portion of the light bar 216 may increase in clockwise manner (e.g., from a bottom of the light bar 216), and vice versa. In addition, the illuminated portion of the light bar may increase around both sides of the light bar 216 (e.g., from the bottom towards a top of the light bar 216) as the amount of amount of power being delivered to the electrical load increases, and vice versa.

The control unit 210 may be configured to transmit one or more wireless signals (e.g., RF signals) to one or more control devices. The control unit 210 may include one or more wireless communication circuits, e.g., RF transmitters, RF receivers, and/or RF transceivers (not shown), via which one or more wireless communication signals may be sent and/or received. The control unit 210 may be configured to transmit messages (e.g., including commands) in response to one or more actuations applied to the control unit 210, such as operation of the rotation portion 212 and/or the actuation portion 214. The control unit 210 may transmit the messages to one or more load control devices associated with the remote control device 200 (e.g., such as the dimmer switch 110, the controllable lighting load 120, the motorized window treatment 130, the temperature control device 140, and/or the controllable audio device 150).

The control unit 210 may be configured to transmit messages including commands for controlling, for example, one or more lighting loads (e.g., the lighting load 112 via the dimmer switch 110 and/or the internal lighting load of the controllable light source 120), for example, when the control unit 210 is operating in a lighting control mode. For example, the control unit 210 may be configured to transmit a message including a command to raise the intensity of the lighting loads in response to a clockwise rotation of the rotation portion 212 and a message including a command to lower the intensity of the lighting loads in response to a counterclockwise rotation of the rotation portion 212. The control unit 210 may be configured to transmit a message including a command to toggle the lighting loads (e.g., from off to on and vice versa) in response to an actuation of the actuation portion 214. The control unit 210 may receive a message including an intensity level of the lighting loads. The light bar 216 may be illuminated to indicate the intensity level of the lighting loads.

The control unit 210 may be configured to transmit messages including commands for controlling, for example, one or more motorized window treatments (e.g., the motorized window treatment 130), for example, when the control unit 210 is operating in a window treatment control mode. For example, the control unit 210 may be configured to transmit a message including a command to increase the amount of daylight entering the space (e.g., by raising the position of the covering material) in response to a clockwise rotation of the rotation portion 212 and a message including a command to decrease the amount of daylight entering the space (e.g., by lowering the position of the covering material) in response to a counterclockwise rotation of the rotation portion 212. The control unit 210 may be configured to transmit a message including a command to control the position of the covering material to a predetermined position in response to an actuation of the actuation portion 214.

The control unit 210 may be configured to transmit messages including commands for controlling, for example, a temperature control device (e.g., the temperature control device 140), for example, when the control unit 210 is operating in a temperature control mode. For example, the control unit 210 may be configured to transmit a message including a command to raise a setpoint temperature of the temperature control device in response to a clockwise rotation of the rotation portion 212 and a message including a command to lower the setpoint temperature of the temperature control device in response to a counterclockwise rotation of the rotation portion 212. The control unit 210 may be configured to transmit messages including commands to turn on and/or off one or more components of a heating, ventilation, and air conditioning system (HVAC) system (e.g., a fan, a compressor, and/or the entire HVAC system) in response to actuations of the actuation portion 214. In addition, the control unit 210 may be configured to transmit a message including a command to change a mode of operation (e.g., changing between a heating mode and a cooling mode, entering and exiting an energy-saver mode, etc.) in response to an actuation of the actuation portion 214.

The control unit 210 may be configured to transmit messages including commands for controlling, for example, one or more speakers (e.g., the controllable audio device 150), for example, when the control unit 210 is operating in an audio control mode. For example, the control unit 210 may be configured to transmit a message including a command to raise the volume of one or more speakers in response to a clockwise rotation of the rotation portion 212 and a message including a command to lower the volume of the speakers in response to a counterclockwise rotation of the rotation portion 212. The control unit 210 may be configured to transmit a message including a command to play or pause playback by the speakers in response to an actuation of the actuation portion 214.

The mounting structure 230 may comprise one or more user input devices, such as actuators 232 (e.g., four actuators as shown in FIG. 2). For example, the actuators 232 may be actuated to select a respective preset (e.g., scene) for controlling the one or more load control devices associated with the remote control device 200. Each preset that may be selected in response to an actuation of one of the actuators 232 may define one or more predefined settings (e.g., levels) to which the load control devices may be controlled. For example, when the control unit 210 is operating in the lighting control mode, the control unit 210 may be configured to transmit lighting presets for controlling the lighting loads to predetermined intensity levels in response to an actuation of one of the actuators 232. In addition, the actuators 232 may be actuated to change the mode in which the control unit 210 is operating (e.g., the lighting control mode, the window treatment control mode, the temperature control mode, and/or the audio control mode). The actuators 232 may be illuminated to indicate a selected preset and/or a selected operating mode. In addition, the one or more user input devices of the mounting structure 230 may comprise a touch sensitive surface, such as a capacitive touch user interface.

The actuators 232 may permit the remote control device 200 to control different functions of a multi-function load control device. For example, a pedestal used to control a motorized window treatment may include two actuators 232A and 232B. When actuated, the first actuator 232A may control the position of the motorized window treatment—rotating the rotation portion 212 clockwise may cause the motorized window treatment to raise and rotating the rotation portion 212 counter-clockwise may cause the motorized window treatment to lower. The second actuator 232B may control another feature of the motorized window treatment, such as the tilt of the slats in a motorized venetian blind—rotating the rotation portion 212 clockwise may cause the slats to rotate in a first direction while and rotating the rotation portion 212 counter-clockwise may cause the slats to rotate in the opposite direction.

In another example, a remote control device 200 used to control a multi-color lamp may include a pedestal having four different actuators, 232A-232D. Actuation of the first actuator 232A may permit the adjustment of the luminous intensity or brightness of the lamp—for example, rotating the rotation portion 212 clockwise may increase the luminous intensity or brightness of the lamp while rotating the rotation portion 212 counter-clockwise may decrease the luminous intensity or brightness of the lamp. Actuation of the second actuator 232B may change the spectral output or color output of the lamp—for example, rotating the rotation portion 212 clockwise may cause the spectral output of the lamp to shift or move toward a longer wavelength (i.e., red) portion of the visible electromagnetic spectrum while rotating the rotation portion 212 counter-clockwise may cause the spectral output of the lamp to shift or move toward a shorter wavelength (i.e., violet) portion of the visible electromagnetic spectrum. Actuation of the third actuator 232C may change the color temperature of the lamp—for example, rotating the rotation portion 212 clockwise may cause the color temperature to shift or move toward a cooler (i.e., higher) color temperature while rotating the rotation portion 212 counter-clockwise may cause the spectral output of the lamp to shift or move toward a warmer (i.e., lower) color temperature. Actuation of the fourth actuator 232D may change the vibrancy of the lamp—for example, rotating the rotation portion 212 clockwise may increase the vibrancy of the luminous output of the lamp while rotating the rotation portion 212 counter-clockwise may decrease the vibrancy of the luminous output of the lamp. While illustrated in terms of brightness, color spectrum, color temperature, and vibrancy, other lighting parameters may be substituted or added to the remote control device 200.

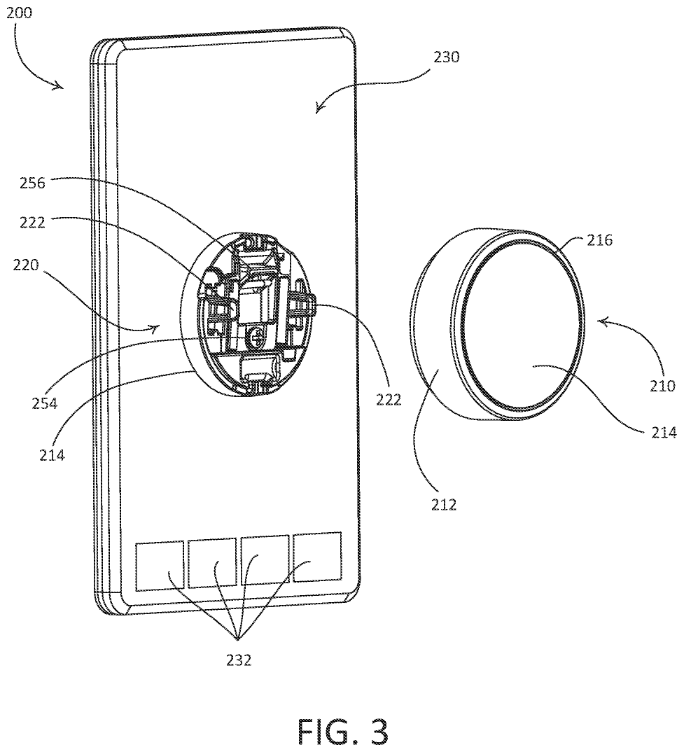

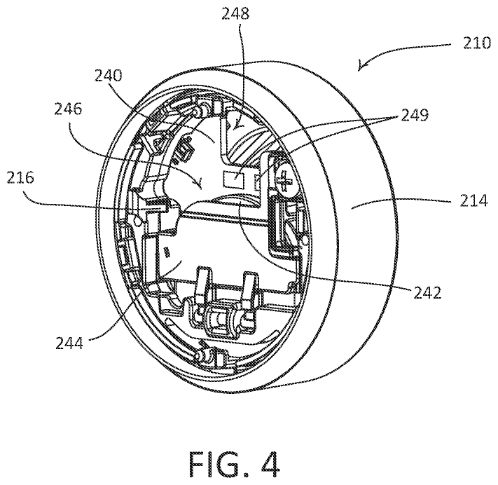

The remote control device 200 may be configured such that the control unit 210 and the base 220 are removably attachable to one another. FIG. 3 is a perspective view of the remote control device 200 with the control unit 210 detached from the base 220. FIG. 4 is a rear perspective view of the control unit 210 when detached from the base 220. For example, the control unit 210 may comprise two tabs 216 configured to snap onto respective attachment clips 222 on the base 220. The control unit 210 may be installed on the base 220 by pushing the control unit 210 towards the base 220 until the tabs 216 of the control unit 210 engage the attachment clips 222. The control unit 210 may be released from the base 220 by pulling the control unit 210 away from the base 220. In addition, the base 220 may include a release mechanism that may be actuated to release the control unit 210 from the base 220. When the control unit 210 is attached to the base 220 (e.g., as shown in FIG. 2), the rotation portion 212 may be rotatable in opposed directions about the base 220, for example in the clockwise or counter-clockwise directions.

The control unit 210 may comprise a control unit printed circuit board (PCB) 240 on which a control circuit, e.g., a processor (not shown), and other electrical circuitry of the control unit 210 may be mounted. The one or more light sources (e.g., LEDs) of the control unit 210 may be mounted to a front side (not shown) of the control unit printed circuit board 240. The processor may be configured to control the light sources to illuminate the upper portion 218 of the actuation portion 214 and/or the light bar 216 to provide visible feedback. The control unit 210 may also comprise one or more batteries, for example, a battery 242 as shown in FIG. 4, for powering the processor and other electrical circuitry mounted to the control unit printed circuit board 240. The control unit 210 may comprise a battery cover 244 for holding the battery 242 in place inside of the control unit 210. A battery compartment 246 may be formed between the printed circuit board 240 and the battery cover 244 for housing the battery 242. The control unit 210 may be removed from the base 220 and the battery cover 244 may be opened to access the battery 242 (e.g., to replace the battery).

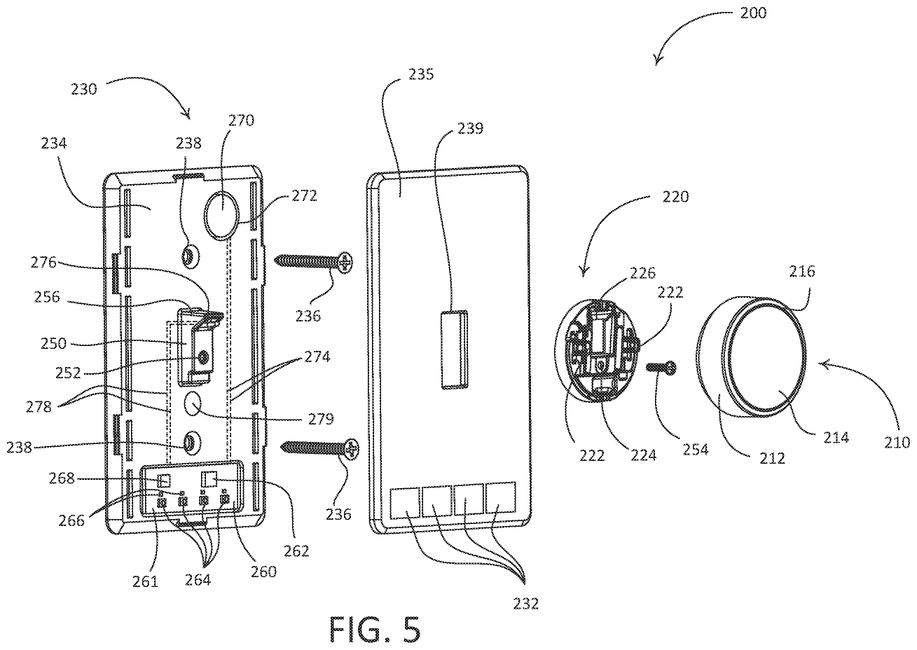

FIG. 5 is an exploded view of the remote control device 200. The base 220 may be configured to be removed from the mounting structure 230. The mounting structure 230 may include a mounting plate 234 and a faceplate 235. The mounting plate 234 may be configured to be mounted to a vertical surface via screws 236 received in openings 238 of the mounting plate 234. The mounting plate 234 may also be configured to be mounted to an electrical wall box. The faceplate 235 may be configured to snap to the mounting plate 234. The mounting structure 230 may comprise a platform 250 that may extend from the mounting plate 234. The base 220 may be configured to be secured to the mounting structure 230 using a fastener 254 received in an aperture 224 in the base 220 and an aperture 252 in the platform 250. The fastener 254 may be self-threading. For example, the aperture 252 may be sized such that the fastener 254 secures the base 220 to the platform 250. Alternatively, the aperture 252 may be threaded such that the aperture 252 has complimentary threads to those of the fastener 254. The mounting plate 234 may comprise a mounting tab 256 that may extend from the platform 250. As shown in FIG. 5, the mounting tab 256 of the mounting plate 230 may extend through an opening 239 in the faceplate and an opening 226 in the base 220. The mounting tab 256 may be configured to prevent rotation of the base 220 when the rotation portion 212 of the control unit 210 is rotated.

The mounting structure 230 may be mounted to the vertical surface with the mounting tab 256 located at the top of the platform 250 and with the mounting tab 256 located at the bottom of the platform 250 (e.g., 180° flip). The processor of the control unit 210 whether the control unit 210 is mounted in one of first and second opposing orientations. The control unit 210 may be in the first orientation when the control unit 210 is mounted to the mounting structure 230 with the mounting tab 256 located at the top of the platform 250, and in the second orientation when the control unit 210 is mounted to the mounting structure 230 with the mounting tab 256 located at the bottom of the platform 250. The processor of the control unit 210 may be configured to determine the orientation of the control unit 210 to determine how to provide the visible feedback. The processor of the control unit 210 may use the determined orientation of the control unit 210 to determine which half of the actuation member 214 is the upper portion 218 and/or to determine which position of the illumination on the light bar 216 is at the bottom to determine how to provide feedback of the intensity level around the light bar. For example, the control unit 210 may include an orientation detect circuit, which may comprise one or more of an accelerometer, a gyroscope, and/or another orientation detection device. An example of a remote control device configured to determine its orientation is described in greater detail in commonly-assigned U.S. Pat. No. 10,134,268, issued Nov. 20, 2018, entitled REMOTE LOAD CONTROL DEVICE CAPABLE OF ORIENTATION DETECTION, the entire disclosure of which is hereby incorporated by reference.

As shown in FIG. 5, the mounting structure 230 may comprise a mounting structure printed circuit board (PCB) 260 on which a control circuit (e.g., a processor 262) may be mounted. The processor 262 may be responsive to actuations of the actuators 232 of the mounting structure 230. The mounting structure 230 may comprise respective tactile switches 264 mounted to a front surface 261 of the mounting structure printed circuit board 260 behind each of the actuators 232. The tactile switches 264 may be electrically coupled to the processor 262, such that the processor is responsive to actuations of the actuators 232. The processor 262 may be configured to determine a selected preset and/or a selected operating mode in response to an actuation of one of the tactile switches 264. The mounting structure 230 may comprise respective light sources 266 (e.g., LEDs) located adjacent to each of the tactile switches 264 for illuminating the respective actuators 232. The processor 262 may be configured to illuminate one of the light sources 266 to indicate a selected preset and/or a selected operating mode.

The mounting structure 230 may comprise an energy storage device, e.g., one or more batteries, such as a battery 270 as shown in FIG. 5. The mounting plate 234 may comprise a battery compartment 272 in which the battery 270 may be received. The battery compartment 272 may be electrically connected to the mounting structure printed circuit board 260 by wires 274. The battery compartment 272 may have battery contacts (not shown) for electrically connecting the battery 270 to the mounting structure printed circuit board 260 via the wires 274 for powering the processor 262 and other electrical circuitry mounted to the mounting structure printed circuit board 260. While not shown in FIG. 5, the mounting plate 234 may comprise additional battery compartments for holding additional batteries. The faceplate 235 of the mounting structure 230 may be removed to access the battery 270 (e.g., to replace the battery 270). The mounting structure 230 may comprise a power terminal (not shown) on a rear side of the mounting plate 234. The power terminal may be electrically connected to the mounting structure printed circuit board 260 and may be configured to be connected to a plug of an external power source, such as a direct-current (DC) power supply (e.g., when the mounting plate 234 is mounted to an electrical wall box). The processor 262 and the electrical circuitry mounted to the mounting structure printed circuit board 260 may be powered from the external power source when the plug is connected to the power terminal. In addition, the battery 270 may be configured to charge from the external power source when the plug is connected to the power terminal.

The control unit 210 may be configured to receive power from the mounting structure 230 when the control unit 210 is mounted to the mounting structure 230 via the base 220. For example, the mounting structure 230 may comprise electrical pins 276 (e.g., pogo pins) configured to extend from the mounting plate 234 towards the control unit 210. The electrical pins 276 may extend towards the control unit 210 adjacent to the mounting tab 256. The electrical pins 276 may be electrically connected to the mounting structure printed circuit board 260 via wires 278 and may be configured to contact electrical pads 249 (FIG. 4) on the control unit printed circuit board 240 when the control unit 210 is mounted to the mounting structure 230. The control unit 210 may be configured to receive power from the battery 270 via the electrical pins 276. For example, the battery 270 (or batteries) coupled to the mounting structure 230 may have a greater energy capacity than the battery 242 (or batteries) coupled to the control unit 210. The control unit 210 may also be configured to receive power from the external power source via the electrical pins 276 when the plug of the external power source is connected to the power terminal on the rear surface of the mounting plate 234. The control unit 210 may be configured to charge the battery 242 using power received via the mounting structure 230. The control unit 210 may be configured to power the electrical circuitry of the control unit 210 directly from the mounting structure 230 (e.g., rather than from the battery 242) when the control unit 210 is mounted to the mounting structure 230. In addition, the control unit 210 may be configured to wirelessly receive power from the mounting structure 230, for example, via magnetic (or inductive) coupling (e.g., the mounting structure 230 may not comprise the electrical pins 276). An example a first control device configured to be wirelessly powered by a second control device is described in greater detail in commonly-assigned U.S. Pat. No. 9,368,025, issued Jun. 14, 2016, entitled TWO-PART LOAD CONTROL SYSTEM MOUNTABLE TO A SINGLE ELECTRICAL WALLBOX, the entire disclosure of which is hereby incorporated by reference.

The processor 262 of the mounting structure 230 may be configured to communicate with the processor of the control unit 210. For example, the mounting structure 230 may comprise a wireless communication circuit (e.g., a wireless communication circuit 268, such as an RF transceiver) that may be mounted to the mounting structure printed circuit board 260 and may be configured to communicate with the wireless communication circuit of the control unit 210. For example, the wireless communication circuits of the control unit 210 and the mounting structure 230 may be configured to communicate wirelessly using a short-range wireless communication protocol, e.g., such as the BLUETOOTH LOW ENERGY (BLE) and/or NEAR-FIELD COMMUNICATION (NFC) protocols. In addition, the processor 262 of the mounting structure 230 and the processor of the control unit 210 may be configured to communicate wirelessly via a magnetic coupling between the control unit 210 and the mounting structure 230 (e.g., via the magnetic coupling through which the control unit 210 may receive power from the mounting structure 230). Further, the processor 262 of the mounting structure 230 and the processor of the control unit 210 may also be configured to communicate via an electrical connection between the control unit 210 and the mounting structure 230. For example, the mounting structure 230 may also comprise additional electrical pins (not shown) for enabling communication between the control unit 210 and the mounting structure 230, or the mounting structure 230 may be configured to provide power and communicate with the control unit 210 via the two electrical pins 276 (e.g., without the need for additional electrical pins).

The processor 262 of the mounting structure 230 may be configured to transmit messages to the processor of the control unit 210 in response to actuations of the actuators 232. For example, the processor of the control unit 210 may be configured to change an operating mode of the control unit 210 (e.g., the lighting control mode, the window treatment control mode, the temperature control mode, and/or the audio control mode) in response to receiving a message from the processor 262 of the mounting structure 230 indicating an actuation of one of the actuators 232. In addition, the processor of the control unit 210 may be configured to transmit a message including a command for a selected present to the load control devices associated with the remote control device 200 in response to receiving a message from the processor 262 of the mounting structure 230 indicating an actuation of one of the actuators 232.

The processor of the control unit 210 may be configured to determine (e.g., automatically determine) that the control unit 210 is mounted to the mounting structure 230 and operate in a mounted mode when mounted to the mounting structure 230. For example, the mounting structure 230 may comprise a magnet 279 (e.g., an internal magnet located in the mounting plate 234), and the processor of the control unit 210 may be configured to determine when the control unit 210 is near the magnet 279. The processor of the control unit 210 may be configured to determine that the control unit 210 is mounted to the mounting structure 230 in response to detecting that the magnet 279 is nearby. In addition, the processor of the control unit 210 may be configured to determine that the control unit 210 is mounted to the mounting structure 230 in response to detecting that the electrical pads 249 are receiving voltage from the electrical pins 278 of the mounting structure 230. The processor of the control unit 210 may be configured to determine that the control unit 210 is mounted to the mounting structure 230 in response to determining that the control unit 210 is oriented vertically to the mounting structure 230 in the first orientation or the second orientation (e.g., in response to the orientation detect circuit). The processor of the control unit 210 may be configured to determine that the control unit 210 is mounted to the mounting structure 230 in response to wireless signals received from the wireless communication circuit 268 of the mounting structure 230, for example, when a received signal strength magnitude (e.g., a received signal strength indicator) of the wireless signals received from the wireless communication circuit 268 of the mounting structure 230 exceeds a signal strength threshold. Further, the processor of the control unit 210 may be configured to operate in the mounted mode in response to receiving inputs when in an advanced programming mode. The processor of the control unit 210 may enter the advanced programming mode in response to actuations of one or more of rotation portion 212 and/or the actuation portion 214. Examples of an advanced programming mode for a wall-mounted load control device can be found in U.S. Pat. No. 7,190,125, issued Mar. 13, 2007, entitled PROGRAMMABLE WALLBOX DIMMER, the entire disclosure of which is hereby incorporated by reference.

The processor of the control unit 210 may begin to operate in the mounted mode in response to determining that the control unit 210 is mounted to the mounting structure 230 and/or in response to inputs received during the advanced programming mode. The processor of the control unit 210 may be configured to determine to charge the battery 242 via the mounting structure 230 and/or bypass the battery 242 to power the electrical circuitry of the control unit 210 directly from the mounting structure 230 when in the mounted mode. In addition, the processor of the control unit 210 may be configured to determine control information (e.g., commands) for controlling one or more electrical loads based on whether the control unit 210 is operating in the mounted mode or not and transmit messages including the control information. The processor of the control unit 210 may be configured to determine which load control devices of the load control system to control in response to whether the control unit 210 is in the mounted mode or not. For example, the control unit 210 may be configured to control a first group of load control devices (e.g., one or more load control devices) in a room when the control unit 210 is operating in the mounted mode, and a second group of load control devices (e.g., all load control devices) in the room when the control unit 210 is not operating in the mounted mode (e.g., when the control unit 210 is operating in a handheld mode as the handheld remote control 160), and vice versa.

The processor of the control unit 210 may be configured to determine how to operate in response to a type (e.g., an identity) of mounting structure 230 to which the control unit 210 is mounted. For example, the control unit 210 may be configured to be mounted to a first mounting structure for controlling lighting loads and a second mounting structure for controlling the volume of an audio system. For example, the processor of the control unit 210 may be configured to determine (e.g., automatically determine) the type of the mounting structure (e.g., which of the first and second mounting structures) to which the control unit 210 is mounted in response to wireless signals received from the wireless communication circuit 268 of the mounting structure 230. When the control unit 210 is mounted to the first mounting structure, the processor of the control unit 210 may be configured to transmit messages including commands for controlling lighting loads in response to actuations of the rotation portion 212 and/or the actuation portion 214. When the control unit 210 is mounted to the second mounting structure, the processor of the control unit 210 may be configured to transmit messages including commands for controlling the state and/or volume of audio devices (e.g., speakers) in response to actuations of the rotation portion 212 and/or the actuation portion 214.

The processor of the control unit 210 and/or the processor 262 of the mounting structure 230 may be configured to determine how to operate in response to a location and/or type of space in which the remote control device 200 is located. For example, the remote control device 200 may be located in rooms having different functions (e.g., offices, conference rooms, classrooms, hallways, foyers, kitchens, dining rooms, bedrooms, etc.). The processor of the control unit 210 and/or the processor 262 of the mounting structure 230 may be configured to determine the location and/or type of space during a configuration procedure of the remote control device 200. In addition, the processor of the control unit 210 and/or the processor 262 of the mounting structure 230 may be configured to determine the location and/or type of space in response to beacon signals received by the wireless communication circuit of the control unit 210 and/or the wireless communication circuit 268 of the mounting structure 230 from a beacon-transmitting device. Further, the processor of the control unit 210 and/or the processor 262 of the mounting structure 230 may be configured to determine the location and/or type of space in response to beacon signals transmitted by the wireless communication circuit of the control unit 210 and/or the wireless communication circuit 268 of the mounting structure 230 to another control device. Examples of control device configured to determine their locations in response to transmitted and/or received beacon signals are described in greater detail in commonly-assigned U.S. Pat. No. 10,599,174, issued Mar. 24, 2020, entitled LOAD CONTROL SYSTEM RESPONSIVE TO THE LOCATION OF AN OCCUPANT AND/OR MOBILE DEVICE, the entire disclosure of which is hereby incorporated by reference. The processor of the control unit 210 and/or the processor 262 of the mounting structure 230 may be configured to transmit messages including commands that are dependent upon the location and/or type of space. For example, presets selected in response to actuations of actuators of a first mounting structure in an office may be different than presets selected in response to actuations of actuators of a second mounting structure in a conference room.

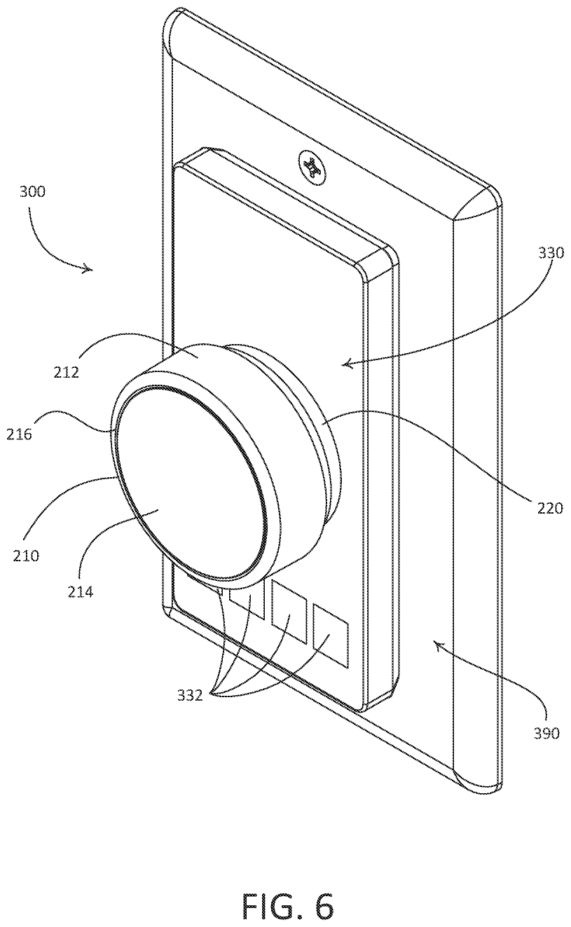

FIG. 6 is a perspective view of another example remote control device 300 (e.g., a battery-powered remote control device) that may be deployed, for example, as the retrofit remote control device 166 of the load control system 100 shown in FIG. 1. The remote control device 200 may include a control unit and a base mounted to a mounting structure, such as a mounting structure 330. For example, the control unit and the base of the remote control device 300 may be the same as the control unit 210 and the base 220, respectively, of the remote control device 200. The mounting structure 330 may be configured to be mounted to a mechanical switch 390 (e.g., such as the toggle switch 126 shown in FIG. 1), which may be mounted to a vertical surface (e.g., a wall). The remote control device 300 may be configured such that the control unit 210 and the base 220 are removably attachable to one another (e.g., as with the remote control device 200). The control unit 210 may be removed from the base 220 to access the battery 242 (e.g., to replace the battery).

The control unit 210 may be responsive to the rotation portion 212 and the actuation portion 214 while the mounting structure 330 is connected on the mechanical switch 390. The control unit 210 may be configured to transmit one or more wireless communication signals (e.g., RF signals) to one or more control devices in response to rotations of the rotation portion 212 and actuations of the actuation portion 214 (e.g., as described above for the remote control device 200). The control unit 210 may be configured to transmit messages including commands for controlling, for example, one or more lighting loads (e.g., when the control unit 210 is operating in a lighting control mode), motorized window treatments (e.g., when the control unit 210 is operating in a window treatment control mode), temperature control devices (e.g., when the control unit 210 is operating in a temperature control mode), and/or speakers (e.g., when the control unit 210 is operating in an audio control mode). The control unit 210 may also be configured to illuminate the light bar 216 to indicate an amount of power being delivered to the electrical load.

The mounting structure 330 may comprise one or more user input devices, such as actuators 332 (e.g., four actuators as shown in FIG. 6). For example, the actuators 332 may be actuated to select a respective preset (e.g., scene or zone) for controlling the one or more load control devices associated with the remote control device 200. Each preset that may be selected in response to an actuation of one of the actuators 332 may define one or more predefined settings (e.g., levels) to which the load control devices may be controlled. For example, when the control unit 210 is operating in the lighting control mode, the control unit 210 may be configured to transmit lighting presets for controlling the lighting loads to predetermined intensity levels in response to an actuation of one of the actuators 332. In addition, the actuators 332 may be actuated to change the mode in which the control unit 210 is operating (e.g., the lighting control mode, the window treatment control mode, the temperature control mode, and/or the audio control mode). In addition, the one or more user input devices of the mounting structure 330 may comprise a touch sensitive surface, such as a capacitive touch user interface.

A zone may include a plurality of load devices which share one or more common adjustment parameters. In such implementations, the actuators 332 may be configured to select a parameter common to all load devices within the zone and the remote control device 200 may be used to adjust the parameter common to all of the load devices. For example, a zone may be defined to include a plurality of lamps, each having an adjustable color spectrum and/or color temperature output. Rather than individually adjusting the color spectrum and/or color temperature of each lamp (a tedious and time consuming prospect which relies upon the user “eyeing” the correct color spectrum and/or color temperature), an actuator 332 on the remote control device 200 may be actuated such that the color spectrum and/or color temperature of each of the plurality of lamps included in the zone is adjusted at one time using the remote control device 200.

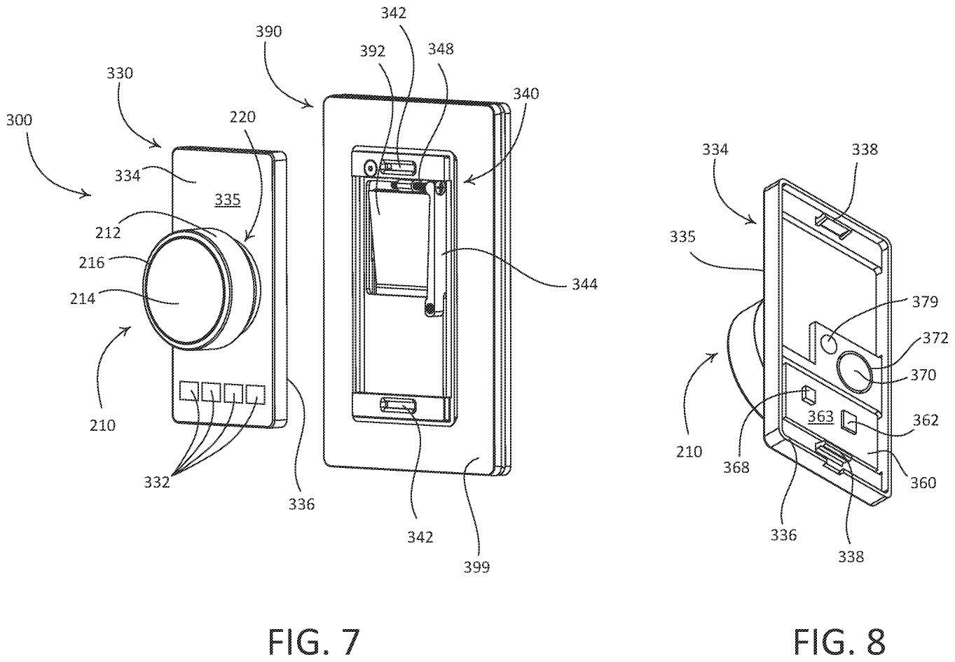

The mounting structure 330 may comprise a cover portion 334 and a mounting frame 340 to which the cover portion 334 may be attached. FIG. 7 is a perspective view of the remote control device 300 showing the cover portion 334 detached from the mounting frame 340. FIG. 8 is a rear perspective view of the cover portion 334. The mounting frame 340 may be configured to be fixedly attached to an actuator 392 of the mechanical switch 390, such as a paddle actuator of the light switch, and may be configured to maintain the actuator in the on position. The cover portion 334 may be configured to cover the actuator 392 of the mechanical switch 390 and receive the mounting frame 340. For example, the base 320 may be attached (e.g., releasably attached) to the cover portion 334. The cover portion 334 may define a front surface 335 and a rear surface 336. The cover portion 334 may include one or more tabs 338 that extend from the rear surface 336. The one or more tabs 338 may be configured to secure the cover portion 334 to the mounting frame 340.

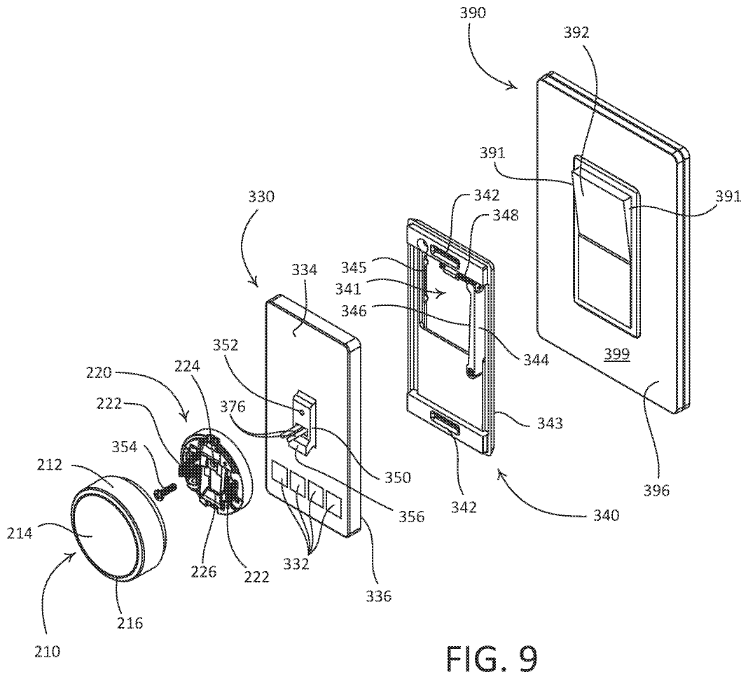

FIG. 9 is an exploded view of the remote control device 300. The cover portion 334 may include a platform 350 that extends from the front surface 335. The pedestal 330 may comprise a platform 350 that may extend from the cover portion 334. The platform 350 may include an aperture 352. The base 220 may be configured to be secured to the pedestal 330 using a fastener 354 received in the aperture 352 of the platform 350. The fastener 354 may be self-threading. For example, the aperture 352 may be sized such that the fastener 354 secures the base 220 to the platform 350. Alternatively, the aperture 352 may be threaded such that the aperture 352 has complimentary threads to those of the fastener 354. A midpoint of the platform 350 may be located slightly offset from the center of the cover portion 334. For example, the platform 350 may be offset from the center of the cover portion 334 such that the control unit 210 is centered on the cover portion 334 when secured to the platform 350. The platform 350 may comprise a mounting tab 356 that may extend from the platform 350. The mounting tab 356 of the pedestal 330 may extend into the opening 224 defined by the base 220 when the base is attached to cover portion 334. The mounting tab 356 may be configured to prevent rotation of the base 220 when the rotation portion 212 of the control unit 210 is rotated.

The mounting frame 340 may be configured to releasably retain the cover portion 334 when the base 220 is attached to the cover portion 334. The mounting frame 340 may define one or more slots 342. The slots 342 may be configured to receive the tabs 338 of the cover portion 334, for example, to secure the cover portion 334 to the mounting frame 340. The mounting frame 340 may include a clamp arm 344 (e.g., a bar), e.g., as shown in FIGS. 7 and 9. The mounting frame 340 may be configured to be mounted over the actuator 392 of the mechanical switch 390. The mounting frame 340 may include a frame opening 341 that extends therethrough. The opening 341 may be configured to receive a portion of the actuator 392. The clamp arm 344 may be configured to secure the mounting frame 340 to the actuator 392. For example, the clamp arm 344 may secure the mounting frame 340 in a mounted position relative to the actuator 392. The clamp arm 344 may cause a rear surface 343 of the mounting frame 340 to be biased against an outer surface 399 of a faceplate 396 of the mechanical switch 390 such that the actuator 392 is maintained in a first position in which power is delivered to the electrical load. The clamp arm 344 may be operable to contact a first side 391 of the actuator 392 such that an opposed second side 393 of the actuator 392 is biased against a corresponding inner wall 345 of the mounting frame 340. The inner wall 345 may define (e.g., partially define) the frame opening 341.

The clamp arm 344 may extend into the frame opening 341. One end of the clamp arm 344 may be supported (e.g., pivotally supported) by the mounting frame 340. The other end of the clamp arm 344 may be translatable toward a center of the frame opening 341 (e.g., toward the inner wall 345). The clamp arm 344 may define an edge 346 that faces the center of the frame opening 341. The edge 346 may be configured to abut the first side 391 of the actuator 392. For example, the edge 346 may abut the first side 391 of the actuator 392 as the clamp arm 344 is translated toward the center of the frame opening 341. The mounting frame 340 may include a screw 348. The screw 348 may operably connect the clamp arm 344 to the mounting frame 340. The screw 348 may be configured to translate the clamp arm 344 toward (e.g., and away from) the inner wall 345. For example, driving the screw 348 (e.g., clockwise) may cause the clamp arm 344 to travel toward the inner wall 345. Driving the screw 348 in the opposite direction (e.g., counter-clockwise) may cause the clamp arm 334 to travel away from the inner wall 345.

As shown in FIG. 8, the mounting structure 330 (e.g., the cover portion 334 of the mounting structure 330) may comprise a mounting structure printed circuit board (PCB) 360 on which a control circuit (e.g., a processor 362) may be mounted. For example, the processor 362 may be mounted to a rear surface 363 of the mounting structure printed circuit board 360 as shown in FIG. 8. The processor 362 may be responsive to actuations of the actuators 332 of the mounting structure 300. The mounting structure 330 may comprise respective tactile switches (e.g., such as the tactile switches 264) mounted to a front surface of the mounting structure printed circuit board 360 behind each of the actuators 332. The tactile switches may be electrically coupled to the processor 362, such that the processor is responsive to actuations of the actuators 332. The processor 362 may be configured to determine a selected preset and/or a selected operating mode in response to an actuation of one of the actuators 332. The mounting structure 330 may comprise respective light sources (e.g., such as the light sources 266) located adjacent to each of the tactile switches on the front surface of the mounting structure printed circuit board 360 for illuminating the respective actuators 332. The processor 362 may be configured to illuminate one of the light sources to indicate a selected preset and/or a selected operating mode.

The mounting structure 330 may comprise an energy storage device, e.g., one or more batteries, such as a battery 370 as shown in FIG. 8. The cover portion 334 of the mounting structure 330 may comprise a battery compartment 372 in which the battery 370 may be received. The battery compartment 372 may be electrically connected to the mounting structure printed circuit board 360. The battery compartment 372 may have battery contacts (not shown) for electrically connecting the battery 370 to the mounting structure printed circuit board 360 for powering the processor 362 and other electrical circuitry mounted to the mounting structure printed circuit board 360. While not shown in FIG. 8, the cover portion 334 may comprise additional battery compartments for holding additional batteries. The cover portion 334 may be removed from the mounting frame 340 to access the battery 370 (e.g., to replace the battery 370).

The control unit 210 may be configured to receive power from the mounting structure 330 when the control unit 210 is mounted to the mounting structure 330 via the base 320. For example, the mounting structure 330 may comprise electrical pins 376 (e.g., pogo pins) configured to extend from the platform 350 towards the control unit 210. The electrical pins 376 may extend towards the control unit 210 adjacent to the mounting tab 356. The electrical pins 376 may be configured to contact the electrical pads 249 on the control unit printed circuit board 240 when the control unit 210 is mounted to the mounting structure 330. The control unit 210 may be configured to receive power from the battery 370 of the mounting structure 330 via the electrical pins 376. For example, the battery 370 (or batteries) of the mounting structure 330 may have a greater energy capacity than the battery 242 (or batteries) of the control unit 210. The control unit 210 may be configured to charge the battery 242 from the battery 370 of the mounting structure 330. The control unit 210 may be configured to power the electrical circuitry of the control unit 210 directly from the mounting structure (e.g., rather than from the battery 242) when the control unit 210 is mounted to the mounting structure 330. In addition, the control unit 210 may be configured to wirelessly receive power from the mounting structure 330, for example, via magnetic coupling (e.g., the mounting structure 330 may not comprise the electrical pins 376).

The processor 362 of the mounting structure 330 may be configured to communicate with the processor of the control unit 210. For example, the mounting structure 330 may comprise a wireless communication circuit (e.g., a wireless communication circuit 368, such as an RF transceiver) that may be mounted to the mounting structure printed circuit board 360 and may be configured to communicate with the wireless communication circuit of the control unit 210. For example, the wireless communication circuits of the control unit 210 and the mounting structure 330 may be configured to communicate wirelessly using a short-range wireless communication protocol. In addition, the processor 362 of the mounting structure 330 and the processor of the control unit 210 may be configured to communicate wirelessly via a magnetic coupling between the control unit 210 and the mounting structure 330 (e.g., via the magnetic coupling through which the control unit 210 may receive power from the mounting structure 230). Further, the processor 362 of the mounting structure 330 and the processor of the control unit 210 may also be configured to communicate via an electrical connection between the control unit 210 and the mounting structure 330. For example, the mounting structure 330 may also comprise additional electrical pins (not shown) for enabling communication between the control unit 210 and the mounting structure 330, or the mounting structure 330 may be configured to provide power and communicate with the control unit 210 via the two electrical pins 376 (e.g., without the need for additional electrical pins).

The processor 362 of the mounting structure 330 may be configured to transmit messages to the processor of the control unit 210 in response to actuations of the actuators 332. For example, the processor of the control unit 210 may be configured to change an operating mode of the control unit 210 (e.g., the lighting control mode, the window treatment control mode, the temperature control mode, and/or the audio control mode) in response to receiving a message from the processor 362 of the mounting structure 330 indicating an actuation of one of the actuators 332. In addition, the processor of the control unit 210 may be configured to transmit a message including a command for a selected preset to the load control devices associated with the remote control device 300 in response to receiving a message from the processor 362 of the mounting structure 330 indicating an actuation of one of the actuators 332.

The processor of the control unit 210 may be configured to determine (e.g., automatically determine) that the control unit 210 is mounted to mounting structure 330 and operate in a mounted mode when mounted to the mounting structure 330. For example, the mounting structure 330 may comprise a magnet 379 (e.g., an internal magnet located in the cover portion 334), and the processor of the control unit 210 may be configured to determine when the control unit 210 near the magnet 379. The processor of the control unit 210 may be configured to determine that the control unit 210 is mounted to the mounting structure 330 in response to detecting that the magnet 379 is nearby. The processor of the control unit 210 may also be configured to determine that the control unit 210 is mounted to the mounting structure 330 in response to detecting that the electrical pads 249 are receiving voltage from the electrical pins 376 of the mounting structure 330. The processor of the control unit 210 may be configured to determine that the control unit 210 is mounted to the mounting structure 330 in response to determining that the control unit 210 is oriented vertically to the mounting structure 330 in the first orientation or the second orientation (e.g., in response to the orientation detect circuit). The processor of the control unit 210 may be configured to determine that the control unit 210 is mounted to the mounting structure 330 in response to wireless signals received from the communication circuit 368 of the mounting structure 330, for example, when a received signal strength magnitude (e.g., a received signal strength indicator) of the wireless signals received from the communication circuit of the mounting structure 330 exceeds a signal strength threshold. Further, the processor of the control unit 210 may be configured to operate in the mounted mode in response to receiving inputs received when in an advanced programming mode. The processor of the control unit 210 may enter the advanced programming mode in response to actuations of one or more of rotation portion 212 and/or the actuation portion 214.

The processor of the control unit 210 may begin to operate in the mounted mode in response to determining that the control unit 210 is mounted to the mounting structure 330 and/or in response to inputs received during the advanced programming mode. The processor of the control unit 210 may be configured to determine to charge the battery 224 via the mounting structure 330 and/or bypass the battery 224 to power the electrical circuitry of the control unit 210 directly from the mounting structure 330 when in the mounted mode. In addition, the processor of the control unit 210 may be configured to determine control information (e.g., commands) for controlling one or more electrical loads based on whether the control unit 210 is operating in the mounted mode or not and transmit messages including the control information. The processor of the control unit 210 may be configured to determine which load control devices of the load control system to control in response to whether the control unit 210 is in the mounted mode or not. For example, the control unit 210 may be configured to control a first group of load control devices (e.g., one or more load control devices) in a room when the control unit 210 is operating in the mounted mode, and a second group of load control devices (e.g., all load control devices) in the room when the control unit 210 is not operating in the mounted mode (e.g., when the control unit 210 is operating in a handheld mode), and vice versa.

The processor of the control unit 210 may be configured to determine how to operate in response to a type of mounting structure 330 to which the control device is mounted. For example, the control unit 210 may be configured to be mounted to a first mounting structure for controlling lighting loads and a second mounting structure for controlling the volume of an audio system. For example, the processor of the control unit 210 may be configured to determine (e.g., automatically determine) which of the first and second mounting structures to which the control device is mounted in response to wireless signals received from the wireless communication circuit 368 of the mounting structure 330. When mounted to the first mounting structure, the processor of the control unit 210 may be configured to transmit messages including commands for controlling lighting loads in response to actuations of the rotation portion 212 and/or the actuation portion 214. When mounted to the second mounting structure, the processor of the control unit 210 may be configured to transmit messages including commands for controlling the state and/or volume of audio devices (e.g., speakers) in response to actuations of the rotation portion 212 and/or the actuation portion 214.

The processor of the control unit 210 and/or the processor 362 of the mounting structure 330 may be configured to determine how to operate in response to a location and/or type of space in which the mounting structure 330 to which the control device is mounted is located. For example, the mounting structure 330 may be mounted in rooms having different functions (e.g., offices, conference rooms, classrooms, hallways, foyers, kitchens, dining rooms, bedrooms, etc.). The processor 362 of the pedestal 330 may be configured to determine the location and/or type of space during a configuration procedure of the remote control device 300. In addition, the processor 362 may be configured to determine the location and/or type of space in response to beacon signals received by the wireless communication circuit 368 from a beacon-transmitting device, and/or in response to beacon signals transmitted by the wireless communication circuit 268 to another control device (e.g., as described in previously-referenced U.S. Pat. No. 10,599,174). For example, the processor of the control unit 210 may be configured to determine (e.g., automatically determine) the location and/or type of space of the mounting structure 330 in response to wireless signals received from the wireless communication circuit of the mounting structure 330. The processor of the control unit 210 and/or the processor 362 of the mounting structure 330 may be configured to transmit messages including commands that are dependent upon the location and/or type of space. For example, presets selected in response to actuations of actuators of a first mounting structure in an office may be different than presets selected in response to actuations of actuators of a first preset in a conference room.

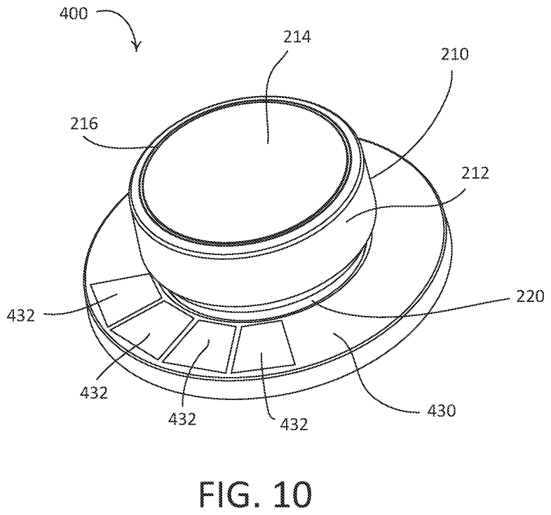

FIG. 10 is a perspective view of another example remote control device 400 (e.g., a battery-powered remote control device) that may be deployed, for example, as the tabletop control device 164 of the load control system 100 shown in FIG. 1. The remote control device 400 may include a control unit and a base mounted to a mounting structure, such as a pedestal 430. The pedestal 430 which may rest on a horizontal surface (e.g., a surface of a table). For example, the control unit and the base of the remote control device 400 may be the same as the control unit 210 and the base 220, respectively, of the remote control device 200 and/or the remote control device 300. The pedestal 430 may be configured to rest on a horizontal surface (e.g., a surface of a table). The control unit 210 may be responsive to the rotation portion 212 and the actuation portion 214 while the pedestal 430 is sitting on the horizontal surface. The control unit 210 may be configured to transmit one or more wireless communication signals (e.g., RF signals) to one or more control devices in response to rotations of the rotation portion 212 and actuations of the actuation portion 214 (e.g., as described above for the remote control device 200).

The control unit 210 may be configured to transmit messages including commands for controlling, for example, one or more lighting loads (e.g., when the control unit 210 is operating in a lighting control mode), motorized window treatments (e.g., when the control unit 210 is operating in a window treatment control mode), temperature control devices (e.g., when the control unit 210 is operating in a temperature control mode), and/or speakers (e.g., when the control unit 210 is operating in an audio control mode). The control unit 210 may also be configured to illuminate the light bar 216 to indicate an amount of power being delivered to the electrical load. The control unit 210 may be configured to disable adjustment of the determined orientation of the control unit 210 when mounted to the pedestal 430. Since the control unit 210 may be configured to determine whether the control unit 210 is mounted in the first orientation or the second orientation (e.g., when mounted to a vertical surface via the mounting structure 230 and/or the mounting structure 330), the control unit 210 may not be able to distinguish between the first and second orientations when the control unit 210 is mounted to the pedestal 430 (e.g., on a horizontal surface). The control unit 210 may be configured to disable adjustment of the determined orientation of the control unit 210 by maintaining the determined orientation constant (e.g., at one of the first or second orientations) when mounted to the pedestal 430 to prevent improper illumination of the light bar 216 and/or a portion of the actuation member 214 (e.g., the upper portion 218 of the actuation member 214 as shown in FIG. 2).

The pedestal 430 may comprise one or more user input devices, such as actuators 432 (e.g., four actuators as shown in FIG. 10). For example, the actuators 432 may be actuated to select a respective preset (e.g., scene) for controlling the one or more load control devices associated with the control unit 210. Each preset that may be selected in response to an actuation of one of the actuators 432 may define one or more predefined settings (e.g., levels) to which the load control devices may be controlled. For example, when the control unit 210 is operating in the lighting control mode, the control unit 210 may be configured to transmit lighting presets for controlling the lighting loads to predetermined intensity levels in response to an actuation of one of the actuators 432. In addition, the actuators 432 may be actuated to change the mode in which the control unit 210 is operating (e.g., the lighting control mode, the window treatment control mode, the temperature control mode, and/or the audio control mode). In addition, the one or more user input devices of the pedestal 430 may comprise a touch sensitive surface, such as a capacitive touch user interface.

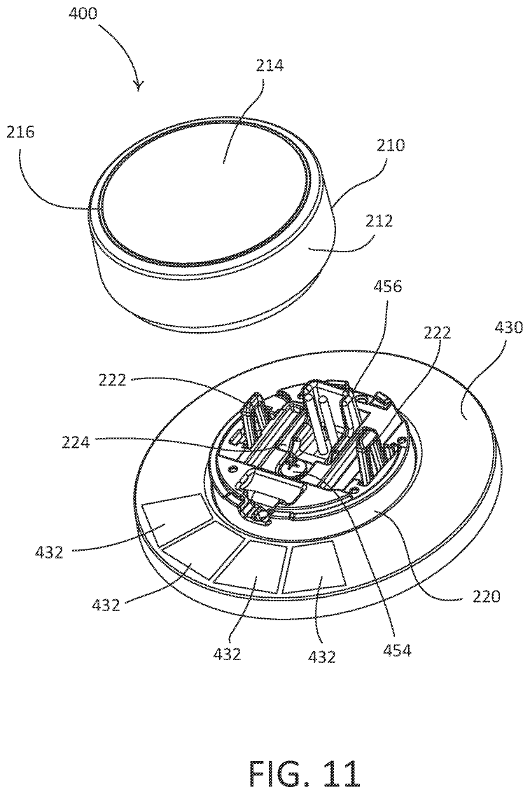

The remote control device 400 may be configured such that the control unit 210 and the base 220 are removably attachable to one another (e.g., as with the remote control device 200 and/or the remote control device 300). FIG. 11 is a perspective view of the remote control device 400 with the control unit 210 detached from the base 220, which is attached to the pedestal 430. The control unit 210 may be removed from the base 220 to access the battery 242 (e.g., to replace the battery).

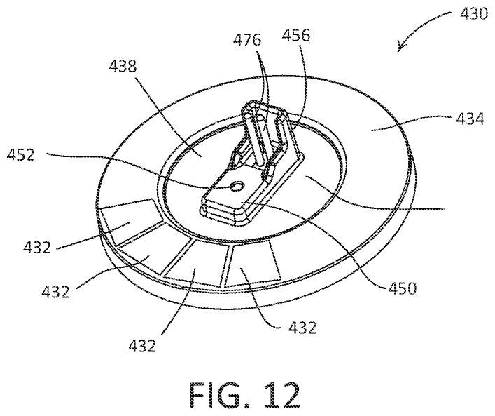

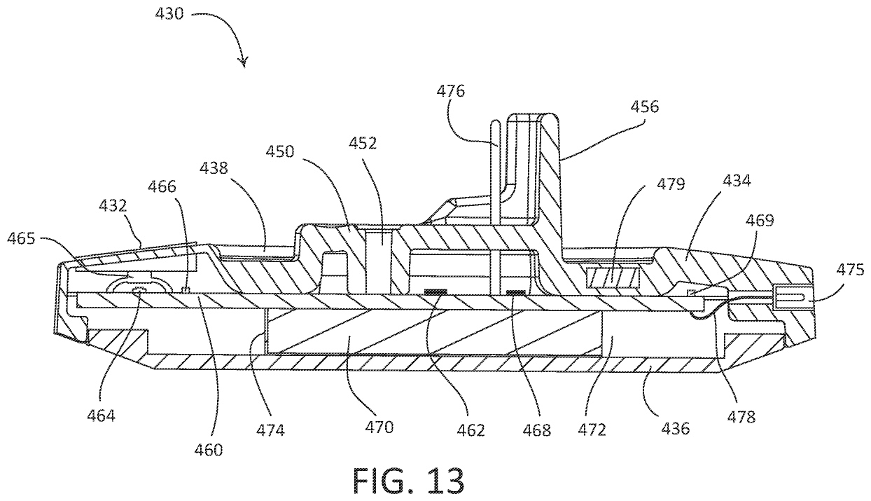

The base 220 may be configured to be removed from the pedestal 430. FIG. 12 is a perspective view of the pedestal 430 with the base 220 removed. FIG. 13 is a side cross-sectional view of the remote control device 400 taken through the center of the pedestal 430. The pedestal 430 may include a plate 434 (e.g., a housing of the pedestal 430) and a pad 436 that may be configured to rest on (e.g., abut) a horizontal surface. For example, the plate 434 may be circular. The actuators 432 may be arranged in an upper portion of the plate 434. The plate 434 of the pedestal 430 may define a cavity 438 configured to receive the base 220. The pedestal 430 may comprise a platform 450 that may extend from the plate 434. A midpoint of the platform 450 may be located slightly offset from the center of the plate 434. For example, the platform 450 may be offset from the center of the plate 434 such that the control unit 210 is centered on the plate 434 when the base 220 is secured to the pedestal 430. The platform 450 may include an aperture 452. The base 220 may be configured to be secured to the pedestal 430 using a fastener 454 (FIG. 11) received in the aperture 452 of the platform 450. The fastener 454 may be self-threading. For example, the aperture 452 may be sized such that the fastener 454 secures the base 220 to the platform 450. Alternatively, the aperture 452 may be threaded such that the aperture 452 has complimentary threads to those of the fastener 454. The pedestal 430 may comprise a mounting tab 456 that may extend from the platform 450. As shown in FIG. 11, the mounting tab 456 of the pedestal 430 may extend into the opening 224 defined by the base 220. The mounting tab 456 may be configured to prevent rotation of the base 220 when the rotation portion 212 of the control unit 210 is rotated.

As shown in FIG. 13, the pedestal 430 may comprise a pedestal printed circuit board (PCB) 460 on which a control circuit (e.g., a processor 462) may be mounted. The processor 462 may be responsive to actuations of the actuators 432 of the pedestal 430. Underneath each of the actuators 432, the pedestal 430 may comprise a respective membrane 465 (e.g., a rubber membrane) positioned over a respective tactile switch 464. The tactile switches 464 may be mounted to the pedestal printed circuit board 460 and electrically coupled to the processor 462, such that the processor 462 is responsive to actuations of the tactile switches 464. When one of the actuators 432 is actuated, the respective rubber membrane 465 may be configured to flex and actuate the respective tactile switch 464. The processor 462 may be configured to determine a selected preset and/or a selected operating mode in response to an actuation of one of the tactile switches 464. The pedestal 430 may comprise respective light sources 466 (e.g., LEDs) mounted to the pedestal printed circuit board 460 adjacent to each of the tactile switches 464 for illuminating the respective actuators 432. The processor 462 may be configured to illuminate one of the light sources 466 to indicate a selected preset and/or a selected operating mode. In addition, the pedestal 430 may comprise an additional light source 469 (e.g., an LED) mounted to the pedestal printed circuit board 460. The processor 462 may be configured to illuminate the light source 469 to provide a nightlight feature, for example, by illuminating a portion (e.g., a translucent portion) of the plate 434.

The pedestal 430 may comprise an energy storage device, e.g., one or more batteries, such as a battery 470 as shown in FIG. 13. The pedestal 430 may comprise a battery compartment 472 in which the battery 470 may be received. The pedestal 430 may comprise a battery contact 474 (e.g., a positive battery contact) that may be located in the battery compartment 472 and may be electrically connected to the pedestal printed circuit board 460 and one of the terminals of the battery 470 (e.g., a positive battery terminal). The battery 470 may be electrically connected between the battery contact 474 and a contact pad (e.g., a negative battery contact) on the pedestal printed circuit board 460 for powering the processor 462 and other electrical circuitry mounted to the pedestal printed circuit board 460. The battery 470 may also be held in place between the battery contact 474 and the contact pad on the pedestal printed circuit board 460. The pad 436 of the pedestal 430 may be removed to access the battery 470 (e.g., to replace the battery 470). The pedestal 430 may comprise a power terminal 475 that may be electrically connected to the pedestal printed circuit board 460 via wiring 478. The power terminal 475 may be configured to be connected to a plug of an external power source, such as a direct-current (DC) power supply. The processor 462 and the electrical circuitry mounted to the pedestal printed circuit board 460 may be powered from the external power source when the plug is connected to the power terminal 475. In addition, the battery 470 may be configured to charge from the external power source when the plug is connected to the power terminal 475.

The control unit 210 may be configured to receive power from the pedestal 430 when the control unit 210 is mounted to the pedestal 430 via the base 220. For example, the pedestal 430 may comprise electrical pins 476 (e.g., pogo pins) configured to extend from the pedestal printed circuit board 460 towards the control unit 210. The electrical pins 476 may extend towards the control unit 210 adjacent to the mounting tab 456. The electrical pins 476 may be configured to contact the electrical pads 249 on the control unit printed circuit board 240 when the control unit 210 is mounted to the pedestal 430. The control unit 210 may be configured to receive power from the battery 470 of the pedestal 430 via the electrical pins 476. For example, the battery 470 (or batteries) of the pedestal 430 may have a greater energy capacity than the battery 242 (or batteries) of the control unit 210. The control unit 210 may also be configured to receive power from the external power source via the electrical pins 476 when the plug of the external power source is connected to the power terminal 475. The control unit 210 may be configured to charge the battery 242 using power received via the pedestal 430. The control unit 210 may be configured to power the electrical circuitry of the control unit 210 directly from the pedestal (e.g., rather than from the battery 242) when the control unit 210 is mounted to the pedestal 430. In addition, the control unit 210 may be configured to wirelessly receive power from the pedestal 430, for example, via magnetic coupling (e.g., the pedestal 430 may not comprise the electrical pins 476).

The processor 462 of the pedestal 430 may be configured to communicate with the processor of the control unit 210. For example, the pedestal 430 may comprise a wireless communication circuit (e.g., a wireless communication circuit 468, such as an RF transceiver) that may be mounted to the pedestal printed circuit board 460 and may be configured to communicate with the wireless communication circuit of the control unit 210. For example, the wireless communication circuits of the control unit 210 and the pedestal 430 may be configured to communicate wirelessly using a short-range wireless communication protocol. In addition, the processor 462 of the pedestal 430 and the processor of the control unit 210 may be configured to communicate wirelessly via a magnetic coupling between the control unit 210 and the pedestal 430 (e.g., via the magnetic coupling through which the control unit 210 may receive power from the pedestal 430). Further, the processor 462 of the pedestal 430 and the processor of the control unit 210 may also be configured to communicate via an electrical connection between the control unit 210 and the pedestal 430. For example, the pedestal 430 may also comprise additional electrical pins (not shown) for enabling communication between the control unit 210 and the pedestal 430, or the pedestal 430 may be configured to provide power and communicate with the control unit 210 via the two electrical pins 476 (e.g., without the need for additional electrical pins).

The processor 462 of the pedestal 430 may be configured to transmit messages to the processor of the control unit 210 in response to actuations of the actuators 432. For example, the processor of the control unit 210 may be configured to change an operating mode of the control unit 210 (e.g., the lighting control mode, the window treatment control mode, the temperature control mode, and/or the audio control mode) in response to receiving a message from the processor 462 of the pedestal 430 indicating an actuation of one of the actuators 432. In addition, the processor of the control unit 210 may be configured to transmit a message including a command for a selected present to the load control devices associated with the remote control device 400 in response to receiving a message from the processor 462 of the pedestal 430 indicating an actuation of one of the actuators 432.

The processor of the control unit 210 may be configured to determine (e.g., automatically determine) that the control unit 210 is mounted to pedestal 430 and operate in a mounted mode when mounted to the pedestal 430. For example, the pedestal 430 may comprise a magnet 479 (e.g., an internal magnet located in the plate 434), and the processor of the control unit 210 may be configured to determine when the control unit 210 near the magnet 479. The processor of the control unit 210 may be configured to determine that the control unit 210 is mounted to the pedestal 430 in response to detecting that the magnet 479 is nearby. The processor of the control unit 210 may also be configured to determine that the control unit 210 is mounted to the pedestal 430 in response to detecting that the electrical pads 249 are receiving voltage from the electrical pins 476 of the pedestal 430. The processor of the control unit 210 may be configured to determine that the control unit 210 is mounted to the pedestal 430 in response to wireless signals received from the communication circuit 468 of the pedestal 430, for example, when a received signal strength magnitude (e.g., a received signal strength indicator) of the wireless signals received from the communication circuit of the pedestal 430 exceeds a signal strength threshold. Further, the processor of the control unit 210 may be configured to operate in the mounted mode in response to receiving inputs received when in an advanced programming mode. The processor of the control unit 210 may enter the advanced programming mode in response to actuations of one or more of rotation portion 212 and/or the actuation portion 214.

The processor of the control unit 210 may begin to operate in the mounted mode in response to determining that the control unit 210 is mounted to the pedestal 430 and/or in response to inputs received during the advanced programming mode. The processor of the control unit 210 may be configured to determine to charge the battery 224 via the pedestal 430 and/or bypass the battery 224 to power the electrical circuitry of the control unit 210 directly from the pedestal 430 when in the mounted mode. In addition, the processor of the control unit 210 may be configured to determine control information (e.g., commands) for controlling one or more electrical loads based on whether the control unit 210 is operating in the mounted mode or not and transmit messages including the control information. The processor of the control unit 210 may be configured to determine which load control devices of the load control system to control in response to whether the control unit 210 is in the mounted mode or not. For example, the control unit 210 may be configured to control a first group of load control devices (e.g., one or more load control devices) in a room when the control unit 210 is operating in the mounted mode, and a second group of load control devices (e.g., all load control devices) in the room when the control unit 210 is not operating in the mounted mode (e.g., when the control unit 210 is operating in a handheld mode), and vice versa.

The processor of the control unit 210 may be configured to determine how to operate in response to a type of pedestal 430 to which the control device is mounted. For example, the control unit 210 may be configured to be mounted to a first pedestal for controlling lighting loads and a second pedestal for controlling the volume of an audio system. For example, the processor of the control unit 210 may be configured to determine (e.g., automatically determine) which of the first and second pedestals to which the control device is mounted in response to wireless signals received from the wireless communication circuit 468 of the pedestal 430. When mounted to the first pedestal, the processor of the control unit 210 may be configured to transmit messages including commands for controlling lighting loads in response to actuations of the rotation portion 212 and/or the actuation portion 214. When mounted to the second pedestal, the processor of the control unit 210 may be configured to transmit messages including commands for controlling the state and/or volume of audio devices (e.g., speakers) in response to actuations of the rotation portion 212 and/or the actuation portion 214.

The processor of the control unit 210 and/or the processor 262 of the pedestal 430 may be configured to determine how to operate in response to a location and/or type of space in which the pedestal 430 to which the control device is mounted is located. For example, the pedestal 430 may be located in rooms having different functions (e.g., offices, conference rooms, classrooms, hallways, foyers, kitchens, dining rooms, bedrooms, etc.). The processor 262 of the pedestal 430 may be configured to determine the location and/or type of space during a configuration procedure of the remote control device 400. In addition, the processor 262 may be configured to determine the location and/or type of space in response to beacon signals received by the wireless communication circuit 468 from a beacon-transmitting device, and/or in response to beacon signals transmitted by the wireless communication circuit 468 to another control device (e.g., as described in previously-referenced U.S. Pat. No. 10,599,174). For example, the processor of the control unit 210 may be configured to determine (e.g., automatically determine) the location and/or type of space of the pedestal 430 in response to wireless signals received from the wireless communication circuit of the pedestal 430. The processor of the control unit 210 and/or the processor 462 of the pedestal 430 may be configured to transmit messages including commands that are dependent upon the location and/or type of space. For example, presets selected in response to actuations of actuators of a first pedestal in an office may be different than presets selected in response to actuations of actuators of a first preset in a conference room. The processor 462 of the pedestal 430 may be configured to determine if the location and/or type of space in which the remote control device 400 is located has changed and update the location and/or type of space.

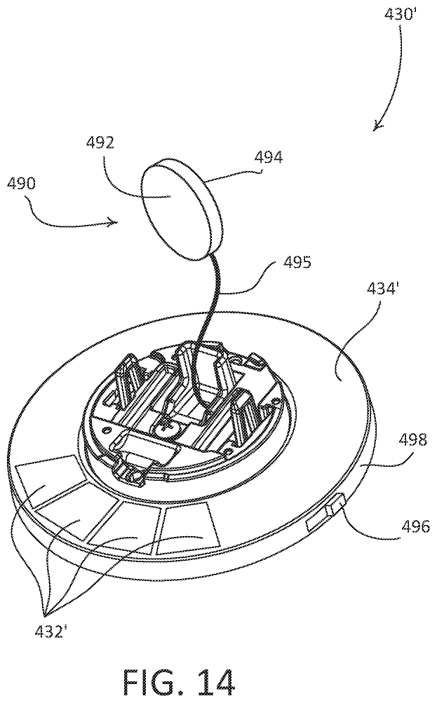

FIG. 14 is a perspective view of another pedestal 430′ to which the control unit 210 and the base 220 may be mounted. The pedestal 430′ may have many of the same elements as the pedestal 430 shown in FIGS. 10-13. For example, the pedestal 430′ may comprise actuators 432′ (e.g., similar to the actuators 432) and a plate 434′ (e.g., similar to the plate 434). Rather than including the electrical pins 476, the pedestal 430′ may comprise an electrical coupling member 490. The electrical coupling member 490 may be disc-shaped and may be approximately the same size as the battery 242 of the control unit 210. The electrical coupling member 490 may comprise a first contact surface 492 (e.g., a positive contact surface) and a second contact surface 494 (e.g., a negative contact surface) opposite the first contact surface 492. The first contact surface 492 and the second contact surface 494 of the electrical coupling member 490 may be electrically coupled to a pedestal printed circuit board (e.g., the pedestal printed circuit board 460) via an electrical wire 495 (e.g., having two electrical conductors) for receiving power from a battery of the pedestal 430′ (e.g., the battery 470) and/or an external power supply via a power terminal (e.g., the power terminal 475). The electrical coupling member 490 may be configured to be received in the battery compartment 246 of the control unit 410 for powering the electrical circuitry of the control unit 410 directly from the battery of the pedestal 430′ and/or the external power supply via the power terminal.

The pedestal 430′ may also comprise a switch 496 located, for example, on a side 498 of a plate 434′ of the pedestal 430′. A processor (e.g., the processor 462) of the pedestal 430′ may be configured to change the operating mode of the pedestal 430′ and/or the control unit 210 (e.g., the lighting control mode, the window treatment control mode, the temperature control mode, and/or the audio control mode) in response to an actuation of the switch 496. For example, the switch 496 may be configured to change between two positions (e.g., to change between the lighting control mode and the audio control mode). In addition, the switch 496 may be configured to be moved between multiple positions (e.g., to change between the lighting control mode, the window treatment control mode, the temperature control mode, and/or the audio control mode). The actuators 432′ may be actuated to select a respective preset (e.g., scene) for controlling one or more load control devices depending upon the selected operating mode.

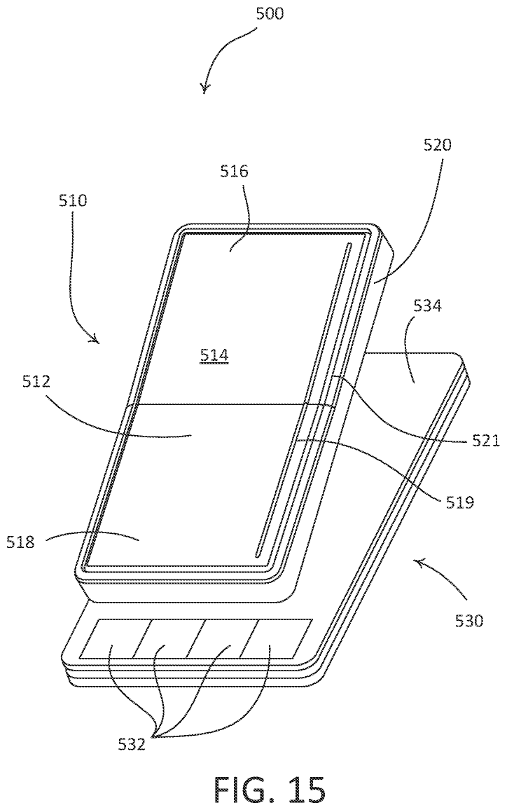

FIG. 15 is a perspective view of another example remote control device 500 (e.g., a battery-powered remote control device) that may be deployed, for example, as the tabletop control device 164 of the load control system 100 shown in FIG. 1. The remote control device 500 may include a control unit 510 (e.g., a control module) that may be mounted to a mounting structure, such as a pedestal 530, which may rest on a horizontal surface (e.g., a surface of a table). The control unit 510 may include a user interface comprising an actuation member 512 that may be attached to a housing 520 and located in an opening 521 of the housing 520. The housing 520 may be rectangular. The actuation member 512 may include a front surface 514 having an upper portion 516 and a lower portion 518. The actuation member 512 may be configured to pivot about a central axis in response to an actuation of the upper portion 516 and the lower portion 518. The control unit 510 may be configured to control an electrical load in response to actuations of the upper portion 516 and the lower portion 518 of the actuation member 512. The front surface 514 of the actuation member 512 may also be configured as a touch sensitive surface (e.g., a capacitive touch surface) that is configured to receive (e.g., detect) inputs, such as touch actuations and/or gestures, from a user of the control unit 510. The control unit 510 may also include a visual display, such as a light bar 519, configured to be illuminated by one or more light sources (e.g., LEDs) to visibly display information. The front surface 514 of the actuation member 512 may be actuated along the light bar 519 to adjust the amount of power delivered to the electrical load according to the position of the actuation.

The control unit 510 of the remote control device 500 may comprise a control circuit, e.g., a processor (not shown), and a wireless communication circuit, e.g., an RF transceiver or transmitter (not shown), for transmitting one or more wireless communication signals (e.g., RF signals) to one or more control devices. The control unit 510 may be configured to transmit messages (e.g., including commands) in response to one or more actuations applied to the control unit 510, such as operation of the actuation member 512 and/or the touch sensitive surface. The control unit 510 may transmit the messages to one or more load control devices associated with the remote control device 500 (e.g., such as the dimmer switch 110, the controllable lighting load 120, the motorized window treatment 130, the temperature control device 140, and/or the controllable audio device 150). The control unit 510 may also comprise one or more batteries (not shown) for powering the processor and other electrical circuitry of the control unit 510.

The control unit 510 may be configured to transmit messages including commands for controlling, for example, one or more lighting loads (e.g., when the control unit 510 is operating in a lighting control mode). For example, the control unit 510 may be configured to transmit a message including a command to turn on the lighting loads in response to an actuation of the upper portion 516 of the actuation member 512, and a message including a command to turn off the lighting loads in response to an actuation of the lower portion 518 of the actuation member 512. The control unit 510 may be configured to transmit a message including a command to adjust the intensity of the lighting loads in response to an actuation of the touch sensitive surface of the actuation member 512 along the length of the light bar 519.

The control unit 510 may be configured to transmit messages including commands for controlling, for example, one or more motorized window treatments (e.g., when the control unit 510 is operating in a window treatment control mode). For example, the control unit 510 may be configured to transmit a command to adjust the amount of daylight entering the space (e.g., by raising or lowering the position of the covering material) in response to an actuation of the touch sensitive surface of the actuation member 512 along the length of the light bar 519. The control unit 510 may be configured to transmit a message including a command to control the position of the covering material to a fully-open position in response to an actuation of the upper portion 516 of the actuation member 512 and a message including a command to control the position of the covering material to a fully-closed position in response to actuations of the lower portion 518 of the actuation member 512.

The control unit 510 may be configured to transmit messages including commands for controlling, for example, a temperature control device (e.g., when the control unit 510 is operating in a temperature control mode). For example, the control unit 510 may be configured to transmit a message including a command to adjust a setpoint temperature of the temperature control device in response to an actuation of the touch sensitive surface of the actuation member 512 along the length of the light bar 519. The control unit 510 may be configured to transmit a message including a command to turn on and/or off (e.g., toggle the state of) one or more components of an HVAC system (e.g., a fan, a compressor, and/or the entire HVAC system) in response to actuations of the upper portion 516 of the actuation member 512. The control unit 510 may be configured to transmit a message including a command to change a mode of operation (e.g., change between a heating mode and a cooling mode, enter and/or exit an energy-saver mode, etc.) in response to an actuation of the lower portion 518 of the actuation member 512.

The control unit 510 may be configured to transmit messages including commands for controlling, for example, one or more speakers (e.g., when the control unit 510 is operating in an audio control mode). For example, the control unit 510 may be configured to transmit a message including a command to adjust the volume of the speakers in response to an actuation of the touch sensitive surface of the actuation member 512 along the length of the light bar 519. The control unit 510 may be configured to transmit a message including a command to play or pause playback by the speakers in response to an actuation of the upper portion 516 of the actuation member 512 and/or a message including a command to skip a track in response to an actuation of the lower portion 518 of the actuation member 512.

The pedestal 530 may comprise one or more user input devices, such as actuators 532 (e.g., four actuators as shown in FIG. 15). For example, the actuators 532 may be actuated to select a respective preset (e.g., scene) for controlling the one or more load control devices associated with the remote control device 500. Each preset that may be selected in response to an actuation of one of the actuators 532 may define one or more predefined settings (e.g., levels) to which the load control devices may be controlled. For example, when the control unit 510 is operating in the lighting control mode, the control unit 510 may be configured to transmit lighting presets for controlling the lighting loads to predetermined intensity levels in response to an actuation of one of the actuators 532. In addition, the actuators 532 may be actuated to change the mode in which the control unit 510 is operating (e.g., between the lighting control mode, the window treatment control mode, the temperature control mode, and/or the audio control mode). In addition, the one or more user input devices of the pedestal 530 may comprise a touch sensitive surface, such as a capacitive touch user interface.

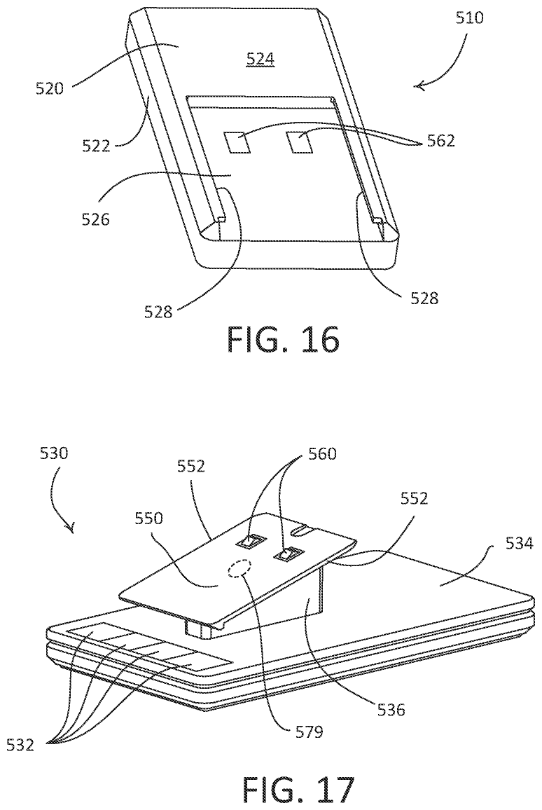

The remote control device 500 may be configured such that the control unit 510 and the pedestal 530 are removably attachable to one another. FIG. 16 is a rear perspective view of the control unit 510 detached from the pedestal 530. FIG. 17 is a perspective view of the pedestal 530 with the control unit 510 removed. As shown in FIG. 16, the housing 520 of the control unit 510 may comprise a front portion 522 and a rear portion 524. The housing of the control unit 510 may enclose a control unit printed circuit board (not shown) on which the control circuit, the wireless communication circuit, and the other electrical circuitry of the control unit 510 may be mounted. The control unit 510 may also comprise one or more batteries (not shown) for powering the processor and other electrical circuitry mounted to the control unit printed circuit board. The one or more batteries may be accessed by detaching the rear portion 524 from the front portion 522 of the housing 520.

The pedestal 530 may include a plate 534 that may be configured to rest on (e.g., abut) a horizontal surface. For example, the plate 534 may be rectangular. The pedestal 530 may comprise a column 536 that may extend from the plate 534 and a platform 550 at the end of the column 536. The platform 550 may be oriented at an angle with respect to the plate 534. The platform 550 may be configured to be received in a platform-receiving portion 526 in the housing 520 of the control unit 410 (e.g., as shown in FIG. 16). The platform 550 may comprise parallel rails 552 configured to be received by parallel flanges 528 of the platform-receiving portion 520. The platform 550 may be slid into the platform-receiving portion 526 of the housing 520 to mount the control unit 510 to the pedestal 530. The platform 550 may be slid out of the platform-receiving portion 526 of the housing 520 to detach the control unit 510 from the pedestal 530.

The pedestal 530 may comprise a pedestal printed circuit board (not shown) on which a control circuit (e.g., a processor) may be mounted. The processor may be responsive to actuations of the actuators 532 of the pedestal 530. The pedestal 530 may have a similar structure as the pedestal 430 shown in FIG. 10 for allowing the processor of the pedestal 530 to be responsive to actuations of the actuators 532 (e.g., the tactile switches 464 and the rubber membranes 465). The processor may be configured to determine a selected preset and/or a selected operating mode in response to an actuation of one of the actuators 532. The pedestal 530 may comprise respective light sources (not shown) located behind each of the respective actuators 532 for illuminating the respective actuators 532 (e.g., such as the light sources 266 located behind the actuators 232 and/or the light sources 466 located behind the actuators 432). The processor may be configured to illuminate one of the light sources to indicate a selected preset and/or a selected operating mode.

The pedestal 530 may also comprise an energy storage device, such as one or more batteries (not shown), that may be housed in the plate 534. The pedestal 530 may comprise a power terminal (not shown) that may be configured to be connected to a plug of an external power source, such as a direct-current (DC) power supply. The processor and the electrical circuitry of the pedestal 530 may be powered from the external power source when the plug is connected to the power terminal. In addition, the one or more batteries of the pedestal 530 may be configured to charge from the external power source when the plug is connected to the power terminal.

The control unit 510 may be configured to receive power from the pedestal 530 when the control unit 510 is mounted to the pedestal 530. For example, the pedestal 530 may comprise electrical contacts 560 (e.g., spring contacts) configured to extend from the platform 550 towards a rear surface of the housing 520 inside of the platform-receiving portion 526. The electrical contacts 560 may be electrically connected to the pedestal printed circuit board inside of the pedestal 530. The electrical contacts 560 may be configured to contact electrical pads 562 (e.g., planar electrical contacts) inside of the platform-receiving portion 526 on the rear surface of the housing 520 when the control unit 510 is mounted to the pedestal 530. The control unit 510 may be configured to receive power from the one or more batteries of the pedestal 530 via the electrical contacts 560. For example, the one or more batteries of the pedestal 530 may have a greater energy capacity than the one or more batteries of the control unit 510. The control unit 510 may also be configured to receive power from the external power source via the electrical contacts 560 when the plug of the external power source is connected to the power terminal. The control unit 510 may be configured to charge the battery of the control unit using power received via the pedestal 530. The control unit 510 may be configured to power the electrical circuitry of the control unit 510 directly from the pedestal (e.g., rather than from the battery of the control unit 510) when the control unit 510 is mounted to the pedestal 530. In addition, the control unit 510 may be configured to wirelessly receive power from the pedestal 530, for example, via magnetic coupling (e.g., the pedestal 530 may not comprise the electrical contacts 560).

The processor of the pedestal 530 may be configured to communicate with the processor of the control unit 510. For example, the pedestal 530 may comprise a wireless communication circuit (e.g., an RF transceiver) that may be mounted to the pedestal printed circuit board and may be configured to communicate with the wireless communication circuit of the control unit 510. For example, the processor of the control unit 510 and the processor of the pedestal 530 may be configured to communicate wirelessly via the wireless communication circuits using a close-range wireless technology. In addition, the processor of the control unit 510 and the processor of the pedestal 530 may be configured to communicate wirelessly via a magnetic coupling between the control unit 510 and the pedestal 530 (e.g., via the magnetic coupling through which the control unit 510 may receive power from the pedestal 530). Further, the processor of the control unit 510 and the processor of the pedestal 530 may also be configured to communicate via an electrical connection between the control unit 510 and the pedestal 530. For example, the control unit 510 may also comprise additional electrical contacts (not shown) for enabling communication between the control unit 510 and the pedestal 530, or the pedestal 530 may be configured to provide power and communicate with the control unit 510 via the two electrical contacts 560 (e.g., without the need for additional electrical contacts).

The processor of the pedestal 530 may be configured to transmit messages to the processor of the control unit 510 in response to actuations of the actuators 532. For example, the processor of the control unit 510 may be configured to change an operating mode of the control unit 510 (e.g., the lighting control mode, the window treatment control mode, the temperature control mode, and/or the audio control mode) in response to receiving a message from the processor of the pedestal 530 indicating an actuation of one of the actuators 532. In addition, the processor of the control unit 510 may be configured to transmit a message including a command for a selected present to the load control devices associated with the remote control device 500 in response to receiving a message from the processor of the pedestal 530 indicating an actuation of one of the actuators 532.

The processor of the control unit 510 may be configured to determine (e.g., automatically determine) that the control unit 510 is mounted to pedestal 530 and operate in a mounted mode when mounted to the pedestal 530. For example, the pedestal 530 may comprise a magnet 579 (e.g., an internal magnet located in the column 536), and the processor of the control unit 510 may be configured to determine when the control unit 510 near the magnet 579. The processor of the control unit 510 may be configured to determine that the control unit 510 is mounted to the pedestal 530 in response to detecting that the magnet 579 is nearby. In addition, the processor of the control unit 510 may be configured to determine that the control unit 510 is mounted to the pedestal 530 in response to an orientation detect circuit (e.g., one or more of an accelerometer, a gyroscope, and/or another orientation detection device). For example, if the processor detects that the control unit 510 is angled (e.g., tilted) as shown in FIG. 15 (e.g., is not vertically oriented as shown in FIG. 2 or horizontally oriented as shown in FIG. 6), the processor of the control unit 510 may determine that the control unit 510 is mounted to the pedestal 530. The processor of the control unit 510 may also be configured to determine that the control unit 510 is mounted to the pedestal 530 in response to detecting that the electrical pads 562 are receiving voltage from the electrical contacts 560 of the pedestal 530. The processor of the control unit 510 may be configured to determine that the control unit 510 is mounted to the pedestal 530 in response to wireless signals received from the communication circuit of the pedestal 530, for example, when a received signal strength magnitude (e.g., a received signal strength indicator) of the wireless signals received from the communication circuit of the pedestal 530 exceeds a signal strength threshold. Further, the processor of the control unit 510 may be configured to operate in the mounted mode in response to receiving inputs received when in an advanced programming mode. The processor of the control unit 510 may enter the advanced programming mode in response to actuations of the actuation member 512.

The processor of the control unit 510 may begin to operate in the mounted mode in response to determining that the control unit 510 is mounted to the pedestal 530 and/or in response to inputs received during the advanced programming mode. The processor of the control unit 510 may be configured to determine to charge the battery of the control unit 510 via the pedestal 530 and/or bypass the battery of the control unit 510 to power the electrical circuitry of the control unit 510 directly from the pedestal 530 when in the mounted mode. In addition, the processor of the control unit 510 may be configured to determine control information (e.g., commands) for controlling one or more electrical loads based on whether the control unit 510 is operating in the mounted mode or not and transmit messages including the control information. The processor of the control unit 510 may be configured to determine which load control devices of the load control system to control in response to whether the control unit 510 is in the mounted mode or not. For example, the control unit 510 may be configured to control a first group of load control devices (e.g., one or more load control devices) in a room when the control unit 510 is operating in the mounted mode, and a second group of load control devices (e.g., all load control devices) in the room when the control unit 510 is not operating in the mounted mode (e.g., when the control unit 510 is operating in a handheld mode), and vice versa.

The processor of the control unit 510 may be configured to determine how to operate in response to a type of pedestal 530 to which the control device is mounted. For example, the control unit 510 may be configured to be mounted to a first pedestal for controlling lighting loads and a second pedestal for controlling the volume of an audio system. For example, the processor of the control unit 510 may be configured to determine (e.g., automatically determine) which of the first and second pedestals to which the control device is mounted in response to wireless signals received from the wireless communication circuit of the pedestal 530. When mounted to the first pedestal, the processor of the control unit 510 may be configured to transmit messages including commands for controlling lighting loads in response to actuations of the actuation member 512. When mounted to the second pedestal, the processor of the control unit 510 may be configured to transmit messages including commands for controlling the state and/or volume of audio devices (e.g., speakers) in response to actuations of the actuation member 512.

The processor of the control unit 510 and/or the processor of the pedestal 530 may be configured to determine how to operate in response to a location and/or type of space in which the pedestal 530 to which the control device is mounted is located. For example, the pedestal 530 may be mounted in rooms having different functions (e.g., offices, conference rooms, classrooms, hallways, foyers, kitchens, dining rooms, bedrooms, etc.). The processor of the pedestal 530 may be configured to determine the location and/or type of space during a configuration procedure of the remote control device 500. In addition, the processor of the pedestal 530 may be configured to determine the location and/or type of space in response to beacon signals received by the wireless communication circuit of the pedestal 530 from a beacon-transmitting device, and/or in response to beacon signals transmitted by the wireless communication circuit of the pedestal 530 to another control device (e.g., as described in previously-referenced U.S. Pat. No. 10,599,174). For example, the processor of the control unit 510 may be configured to determine (e.g., automatically determine) the location and/or type of space of the pedestal 530 in response to wireless signals received from the wireless communication circuit of the pedestal 530. The processor of the control unit 510 and/or the processor of the pedestal 530 may be configured to transmit messages including commands that are dependent upon the location and/or type of space. For example, presets selected in response to actuations of actuators of a first pedestal in an office may be different than presets selected in response to actuations of actuators of a first preset in a conference room. The processor of the pedestal 530 may be configured to determine if the location and/or type of space in which the remote control device 500 is located has changed and update the location and/or type of space.

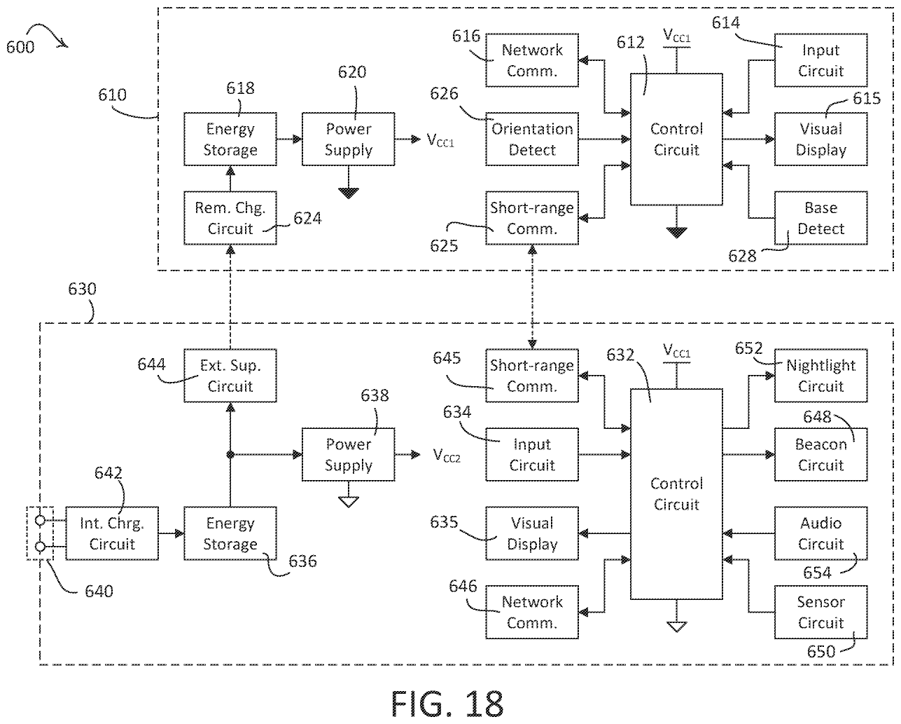

FIG. 18 is a simplified block diagram of an example control device 600 (e.g., a battery-powered remote control device) that may be deployed, for example, as the handheld remote control device 160, the wall-mounted remote control device 162, the tabletop remote control device 164, and/or the retrofit remote control device 166 shown in FIG. 1, the remote control device 200 shown in FIG. 2, the remote control device 300 shown in FIG. 6, the remote control device 400 shown in FIG. 10, and/or the remote control device 500 shown in FIG. 15. The control device 600 may comprise a control unit 610 (e.g., the control unit 210, the control unit 410, and/or the control unit 510) and a mounting unit 630 (e.g., one of the mounting structures 230, 330 and/or the pedestals 430, 530). The control unit 610 may be configured to be mounted to the mounting unit 630 (e.g., in a similar manner as the control unit 210 is mounted to the mounting structures 230, 330 or the pedestal 430, and/or as the control unit 510 is mounted to the pedestal 530).

The control unit 610 may comprise a control circuit 612. For example, the control circuit 612 of the control unit 610 may comprise one or more of a processor (e.g., a microprocessor), a microcontroller, a programmable logic device (PLD), a field programmable gate array (FPGA), an application specific integrated circuit (ASIC), or any suitable controller or processing device. The control unit 610 may include a memory (not shown). The memory may be communicatively coupled to the control circuit 612 for the storage and/or retrieval of, for example, operational settings. The memory may be implemented as an external integrated circuit (IC) or as an internal circuit of the control circuit 612.

The control unit 610 may comprise an input circuit 614 for receiving user inputs. For example, the input circuit 614 may comprise one or more mechanical switches (e.g., the tactile switches) configured to be actuated in response to actuations of respective actuators. For example, the mechanical switches of the input circuit 614 may be actuated in response to actuations of the actuation portion 214 of the control unit 210 and/or the upper portion 516 or lower portion 518 of the actuation member 512 of the control unit 510. In addition, the input circuit 614 may comprise a linear position sensing circuit (e.g., a linear potentiometer) and/or a rotational position sensing circuit (e.g., a rotary potentiometer and/or a magnetic sensing circuit, such as a Hall-effect sensing circuit) responsive to rotations of a rotary knob (e.g., the rotation portion 212 of the control unit 210). Further, the input circuit 614 may comprise a capacitive touch circuit responsive to actuation of a capacitive touch surface (e.g., the front surface 514 of the actuation member 512 of the control unit 510).

The control unit 610 may further comprise a visual display circuit 615. The visual display circuit 615 may comprise, for example, one or more light sources, such as light-emitting diodes (LEDs), configured to be illuminated to provide visible feedback to a user of the control device 600. For example, the control circuit 612 may be configured to control light sources of the visual display circuit 615 to illuminate a light bar (e.g., the light bar 216 of the control unit 210 and/or the light bar 519 of the control unit 510) to provide visible feedback. In addition, the control circuit 612 may be configured to control the light sources of the visual display circuit 615 to illuminate a portion of a front surface of the control unit 610 (e.g., the upper portion 218 of the actuation portion 214) to provide visible feedback.

The control unit 610 may further comprise a network communication circuit 616. The control circuit 612 of the control unit 610 may be configured to communicate messages with other control devices of a load control system via the network communication circuit 616. For example, the network communication circuit 616 may be configured to communicate wireless signals (e.g., the RF signals 104) on a wireless communication link (e.g., a network) of the load control system. The control circuit 632 of the control unit 610 may be configured to transmit messages (e.g., digital messages) including commands for controlling one or more load control devices (e.g., the dimmer switch 110, the controllable lighting device 120, the motorized window treatment 130, the temperature control device 140, and/or the audio device 150) via the network communication circuit 616. While the network communication circuit 616 of the control unit 610 is shown as a separate block in FIG. 18, the network communication circuit 616 may be implemented as an internal circuit of the control circuit 612.

The control unit 610 may further comprise an energy storage device 618, such as one or more batteries (e.g., the battery 242 of the control unit 210 and/or the battery of the control unit 510) and a power supply 620 for generating a supply voltage V_{CC1} for powering the control circuit 612, the input circuit 614, the visual display circuit 615, the network communication circuit 616, and other low-voltage circuitry of the control unit 610.

The control unit 610 may further comprise an orientation detect circuit 626 (e.g., one or more of an accelerometer, a gyroscope, and/or another orientation detection device). The control circuit 612 of the control unit 610 may be configured to detect an orientation in which the control unit 610 is mounted. For example, the control circuit 612 may be configured to determine when the control unit 610 is oriented in a first orientation or a second orientation (e.g., 180° flip) in response to the orientation detect circuit 626 when the mounting unit 630 is mounted to a vertical surface (e.g., when the mounting structure 230 shown in FIG. 2 and/or the mounting structure 330 shown in FIG. 6 is mounted to a vertical surface). The control circuit 612 may be configured to determine the orientation of the control unit 610 to determine how to illuminate the light sources of the visual display circuit 615 to provide the visible feedback. For example, the control unit 610 may use the determined orientation of the control unit 610 to determine position of illumination on the light bar 216 is at the bottom of the actuation member 214 to determine how to provide visible feedback of the intensity level around the light bar. In addition, the control unit 610 may use the determined orientation of the control unit 610 to determine which half of the actuation member 214 is the upper portion 218 on which to provide visible feedback.

The mounting unit 630 may comprise a control circuit 632. For example, the control circuit 632 of the mounting unit 630 may comprise one or more of a processor (e.g., a microprocessor), a microcontroller, a programmable logic device (PLD), a field programmable gate array (FPGA), an application specific integrated circuit (ASIC), or any suitable controller or processing device. The mounting unit 630 may include a memory (not shown). The memory may be communicatively coupled to the control circuit 632 for the storage and/or retrieval of, for example, operational settings. The memory may be implemented as an external integrated circuit (IC) or as an internal circuit of the control circuit 632.

The mounting unit 630 may comprise an input circuit 634 for receiving user inputs. For example, the input circuit 634 may comprise one or more mechanical switches (e.g., the tactile switches 264 of the mounting structure 230, the tactile switches of the mounting structure 330, the tactile switches 464 of the pedestal 430, and/or the tactile switches of the pedestal 530) configured to be actuated in response to actuations of respective actuators (e.g., the actuators 232, 332, 432, 532). For example, the mechanical switches of the input circuit 634 may be actuated to select a respective preset (e.g., scene) for controlling the one or more load control devices associated with the control device 600. In addition, the mechanical switches of the input circuit 634 may be actuated to change the mode in which the control device 600 is operating (e.g., a lighting control mode, a window treatment control mode, a temperature control mode, and/or an audio control mode). The mounting unit 630 may further comprise a visual display circuit 635. The visual display circuit 635 may comprise, for example, one or more light sources, such as light-emitting diodes (LEDs), configured to be illuminated to provide feedback to a user of the control device 600. For example, the light sources of the visual display circuit 635 may be configured to illuminate the actuators that actuated the mechanical switches of the input circuit 634 of the mounting unit 630 to indicate a selected preset and/or operating mode.

The mounting unit 630 may comprise an energy storage device 636, such as one or more batteries (e.g., the battery 270 of the mounting structure 230, the battery 370 of the mounting structure 330, the battery 470 of the pedestal 430, and/or the battery of the pedestal 530) and a power supply 638 for generating a supply voltage V_{CC2} for powering the control circuit 632, the input circuit 634, the visual display circuit 635, and other low-voltage circuitry of the mounting unit 630. The mounting unit 630 may comprise a power terminal 640 (e.g., the power terminal 274 of the mounting structure 230, the power terminal of the mounting structure 330, the power terminal of the pedestal 430, and/or the power terminal of the pedestal 530) that may be configured to be connected to a plug of an external power source, such as a direct-current (DC) power supply. The energy storage device 636 may be configured to charge from the external power source via an internal charging circuit 642 when the plug is connected to the power terminal 640.

The control unit 610 may be configured to receive power from the mounting unit 630 when the control unit 610 is mounted to the mounting unit 630. The energy storage device 618 of the control unit 610 may be configured to charge from the energy storage device 636 of the mounting unit 630 via an external supply circuit 644 of the mounting unit 630 and a remote charging circuit 624 of the control unit 610. For example, the external supply circuit 644 of the mounting unit 630 may be electrically connected to the remote charging circuit 624 of the control unit 610 via electrical pins and/or contacts (e.g., the electrical pins 276, 378, 478 and/or the electrical contacts 560) for changing the energy storage device 618. In addition, the remote supply circuit 644 of the mounting unit 630 may be wirelessly (e.g., magnetically) coupled to the external charging circuit 624 of the control unit 610, for example, via a magnetic coupling (e.g., as described in previously-referenced U.S. Pat. No. 9,368,025).

The control circuit 612 of the control unit 610 may be configured to communicate with the control circuit 632 of the mounting unit 630. For example, the control unit 610 and the mounting unit 630 may comprise respective short-range communication circuits 625, 645. For example, the short-range communication circuits 625, 645 may comprise short-range wireless communication circuits (e.g., RF transceivers) configured to communicate wirelessly using a short-range wireless protocol. In addition, the short-range communication circuits 625, 645 may be configured to communicate wirelessly via a magnetic coupling between the control unit 610 and the mounting unit 630 (e.g., via the magnetic coupling through which the control unit 610 may receive power from the mounting unit 630). Further, the short-range communication circuits 625, 645 may also be configured to communicate via an electrical connection between the control unit 610 and the mounting unit 630, for example, via electrical pins and/or contacts (e.g., the electrical pins 276, 378, 478 and/or the electrical contacts 650). While the short-range communication circuits 625, 645 are shown as separate blocks in FIG. 18, the short-range communication circuits 625, 645 may be implemented as internal circuits of the control circuit 612 of the control unit 610 and the control circuit 632 of the mounting unit 630, respectively.

The control circuit 632 of the mounting unit 630 may be configured to transmit a message including an indication of an actuation of one of the actuators of the mounting unit 630 to the control circuit 612 of the control unit 610 via the short-range communication circuits 625, 645 in response to an actuation of one of the mechanical switches of the input circuit 634 of the mounting unit 630. The control circuit 612 of the control unit 610 may be configured to select a preset (e.g., scene) for controlling the one or more load control devices associated with the control device 600 in response to an actuation of one of the mechanical switches of the input circuit 634 of the mounting unit 630 (e.g., in response to a message received via the short-range communication circuit 625). The control circuit 612 of the control unit 610 may be configured to transmit a message including the selected preset via the network communication circuit 616. For example, when the control unit 610 is operating in a lighting control mode, the control circuit 612 of the control unit 610 may be configured to transmit a message including a lighting preset for controlling lighting loads to predetermined intensity levels in response to an actuation of one of the mechanical switches of the input circuit 634 of the mounting unit 630. In addition, the control circuit 612 of the control unit 610 may be configured to change the mode in which the control unit 610 is operating (e.g., the lighting control mode, the window treatment control mode, the temperature control mode, and/or the audio control mode) in response to an actuation of one of the mechanical switches of the input circuit 634 of the mounting unit 630 (e.g., in response to a message received via the short-range communication circuit 625).

The mounting unit 630 may further comprise a network communication circuit 646. The control circuit 632 of the mounting unit 630 may be configured to communicate messages with other control devices of the load control system via the network communication circuit 646. For example, the network communication circuit 646 may be configured to communicate wireless signals (e.g., the RF signals 104) on the wireless communication link (e.g., the network) of the load control system. The control circuit 632 of the mounting unit 630 may be configured to transmit messages (e.g., digital messages) including commands for controlling one or more load control devices (e.g., the dimmer switch 110, the controllable lighting device 120, the motorized window treatment 130, the temperature control device 140, and/or the audio device 150) via the network communication circuit 646. While the network communication circuit 646 of the mounting unit 630 is shown as a separate block in FIG. 18, the network communication circuit 646 may be implemented as an internal circuit of the control circuit 632.

The control circuit 612 of the control unit 610 and/or the control circuit 632 of the mounting unit 630 may be configured to determine how to operate in response to a location and/or type of space in which the remote control device 600 is located. For example, the remote control device 600 may be located in rooms having different functions (e.g., offices, conference rooms, classrooms, hallways, foyers, kitchens, dining rooms, bedrooms, etc.). The control circuit 612 of the control unit 610 and/or the control circuit 632 of the mounting unit 630 may be configured to determine the location and/or type of space during a configuration procedure of the remote control device 600. In addition, the control circuit 612 of the control unit 610 and/or the control circuit 632 of the mounting unit 630 may be configured to determine the location and/or type of space in response to beacon signals received by the short-range communication circuits 625, 645 from a beacon-transmitting device. The mounting unit 630 may comprise a beacon-transmitting circuit 648 that may be configured to transmit beacon signals. The control circuit 612 of the control unit 610 and/or the control circuit 632 of the mounting unit 630 may be configured to determine the location and/or type of space in response to beacon signals transmitted by the short-range communication circuits 625, 645 and/or the beacon-transmitting circuit 648 of the mounting unit 630 to another control device. For example, the beacon signals may each comprise a wireless signal (e.g., an RF signal) including a beacon identifier transmitted using a short-range wireless protocol. The control circuit 612 of the control unit 610 and/or the control circuit 632 of the mounting unit 630 may be configured to transmit messages including commands that are dependent upon the location and/or type of space. For example, presets selected in response to actuations of actuators of a first mounting structure in an office may be different than presets selected in response to actuations of actuators of a second mounting structure in a conference room.

The control circuit 612 of the control unit 610 may be configured to determine (e.g., automatically determine) that the control unit 610 is mounted to the mounting unit 630. The control circuit 612 of the control unit 610 may be configured to operate in a mounted mode in response to determining that the control unit 610 is mounted to the mounting unit 630. The control unit 610 may comprise a base detect circuit 628. For example, the base detect circuit 628 may comprise a magnetic sensing circuit configured to detect the presence of a magnet (not shown) of the mounting unit 630 (e.g., the magnets 279, 379, 479, 579 of the mounting structures 230, 330 and the pedestals 430, 540, respectively). The control circuit 612 of the control unit 610 may be configured to determine that the control unit 610 is mounted to the mounting unit 630 in response to detecting that the magnet of the mounting unit 630 is nearby. In addition, the control circuit 612 of the control unit 610 may be configured to determine that the control unit 610 is mounted to the mounting unit 630 in response to detecting that the remote charging circuit 624 of the control unit 610 is electrically connected to the external supply circuit 644 of the mounting unit 630 (e.g., via the electrical pins 276, 378, 478 and/or the electrical contacts 560). The control circuit 612 of the control unit 610 may be configured to determine that the control unit 510 is mounted to the mounting unit 630 in response to the orientation detect circuit 626, for example, by determining that the control unit 610 is in a vertical orientation (e.g., when mounted to the mounting structures 230, 330) or in an angled orientation (e.g., when mounted to the pedestal 530). The control circuit 612 of the control unit 610 may be configured to determine that the control unit 610 is mounted to the mounting unit 630 in response to wireless signals and/or beacon signals received by the short-range communication circuit 625 from the short-range communication circuit 645 of the mounting unit 630 and/or the beacon-transmitting circuit 648 of the mounting unit 630. For example, the control circuit 612 of the control unit 610 may be configured to determine that the control unit 610 is mounted to the mounting unit 630 when a received signal strength magnitude (e.g., a received signal strength indicator) of one or more of the received wireless signals and/or beacon signals exceeds a signal strength threshold. Further, the control circuit 612 of the control unit 610 may be configured to operate in the mounted mode in response to receiving inputs when in an advanced programming mode. The control circuit 612 of the control unit 610 may enter the advanced programming mode in response to actuations of the mechanical switches of the input circuit 614 of the control unit 610 and/or the input circuit 634 of the mounting unit 630.

The control circuit 612 of the control unit 610 may begin to operate in the mounted mode in response to determining that the control unit 610 is mounted to the mounting unit 630 and/or in response to inputs received during the advanced programming mode. The control circuit 612 of the control unit 610 may be configured to control the remote charging circuit 624 to charge the energy storage device 636 through the external supply circuit 644 of the mounting unit 630 and/or bypass the energy storage device 636 to power the electrical circuitry of the control unit 610 directly from the mounting unit 630 when in the mounted mode. In addition, the control circuit 612 of the control unit 610 may be configured to determine control information (e.g., commands) for controlling one or more electrical loads based on whether the control unit 210 is operating in the mounted mode or not and transmit messages including the control information via the network communication circuit 646. The control circuit 612 of the control unit 610 may be configured to determine which load control devices of the load control system to control in response to whether the control unit 610 is in the mounted mode or not. For example, the control circuit 612 of the control unit 610 may be configured to transmit messages including control information to control a first group of load control devices (e.g., one or more load control devices) in a room when the control unit 610 is operating in the mounted mode, and a second group of load control devices (e.g., all load control devices) in the room when the control unit 610 is not operating in the mounted mode (e.g., when the control unit 610 is operating in a handheld mode as the handheld remote control 160), and vice versa.

The control circuit 612 of the control unit 610 may be configured to determine how to operate in response to a type of mounting unit 630 to which the control unit 610 is mounted. For example, the control unit 610 may be configured to be mounted to a first mounting unit for controlling lighting loads and a second mounting unit for controlling the volume of an audio system. For example, the control circuit 612 of the control unit 610 may be configured to determine (e.g., automatically determine) the type of the mounting unit (e.g., which of the first and second mounting units) to which the control unit 610 is mounted in response to receiving a message including the type of mounting unit from the short-range communication circuit 645 of the mounting unit 630. When the control unit 610 is mounted to the first mounting structure, the control circuit 612 of the control unit 610 may be configured to transmit messages including commands for controlling lighting loads in response to inputs received via the input circuit 634. When the control unit 610 is mounted to the second mounting structure, the control circuit 612 of the control unit 610 may be configured to transmit messages including commands for controlling the state and/or volume of audio devices (e.g., speakers) in response to inputs received via the input circuit 634.

The control circuit 612 may be configured to disable adjustment of the orientation of the control unit 610 when the orientation of the control unit 610 is determined to be mounted to a horizontally-oriented pedestal (e.g., the pedestal 430 shown in FIG. 10). The control circuit 612 may be configured to disable adjustment of the orientation of the control unit 610 to prevent improper illumination of the light bar 216, 519 and/or the upper portion 218 of the actuation member 214. The control circuit 612 may be configured to disable adjustment of the orientation of the control unit 610 by maintaining the orientation constant (e.g., at one of the first or second orientations) when the orientation of the control unit 610 is determined to be horizontal. The control circuit 612 may be configured to lock the orientation of the control unit 610 at one of the first or second orientations until the orientation of the control circuit 610 is determined to be vertical at which time the control circuit 612 may be configured to determine one of the first or second orientations in which the control unit 610 is oriented.

The mounting unit 630 may also comprise a sensor circuit 650 configured to determine an environmental characteristic in the area around the control device 600. The control circuit 632 of the mounting unit 630 may be configured to transmit messages indicating the determined environmental characteristic to the control circuit 612 of the control unit 610 via the short-range communication circuits 625, 645. The control circuit 612 of the control unit 610 may be configured to transmit messages including the determined environmental characteristic and/or control information (e.g., commands) for controlling the electrical loads via the network communication circuit 616 in response to the determined environmental characteristic.

The sensor circuit 650 may comprise, for example, an occupancy sensing circuit configured to detect an occupancy and/or vacancy condition in the area around the remote control device 600. The occupancy sensing circuit may comprise, for example, a passive infrared (PIR) occupancy sensing circuit, an ultrasonic occupancy sensing circuit, a microwave occupancy sensing circuit, a radar occupancy sensing circuit, a visible light sensing circuit (e.g., a camera), and/or other suitable occupancy sensing circuits. For example, the control circuit 612 of the control unit 610 may be configured to transmit messages including commands for turning on the electrical loads in response to the sensor circuit 650 detecting an occupancy condition and commands for turning off the electrical loads in response to the sensor circuit 650 detecting a vacancy condition.

The sensor circuit 650 may also comprise, for example, a temperature sensing circuit configured to measure a temperature in the area around the remote control device 600. The control circuit 610 of the control unit 612 may be configured to transmit a message including the measure temperature via the network communication circuit 616. The control circuit 610 of control unit 612 may be configured to ignore the measure temperature (e.g., by not transmitting the measured temperature) in response to the orientation detect circuit (e.g., an accelerometer) indicating that the remote control device 600 is moving (e.g., indicating that the control unit 610 may be mounted to a pedestal (e.g., the pedestals 430, 530) and may be being moved around).

The sensor circuit 650 may comprise, for example, a photosensitive sensing circuit (e.g., daylight sensing circuit) configured to measure an ambient light level in the area around the remote control device 600. The control circuit 632 of the mounting unit 630 may be configured to control a nightlight circuit 652 (e.g., the light source 469 of the pedestal 430) in response to the measured ambient light level. The control circuit 632 of the mounting unit 630 may be configured to control the nightlight circuit 652 to illuminate (e.g., to provide a nightlight feature) when the ambient light level is low. In addition, the sensor circuit 650 may comprise, for example, a humidity sensing circuit, a color temperature sensing circuit, and/or other suitable sensing circuits.

The mounting unit 630 may also comprise an audio circuit 654, e.g., a speaker for receiving audio signals. For example, the control circuit 612 of the control unit 610 and/or the control circuit 632 of the mounting unit 630 may be configured to receive a voice command via the audio circuit 654. The control circuit 612 of the control unit 610 and/or the control circuit 632 of the mounting unit 630 may be configured to transmit a message including control information (e.g., a command) via the network communication circuits 616, 646 in response to the received voice command. In addition, the control circuit 632 of the mounting unit 630 may be configured to transmit messages including the audio signals and/or the voice command via the network communication circuit 646 to an external processing device (e.g., a cloud server) for processing (e.g., via the network communication circuit 646 of the mounting unit 630). Further, the audio circuit 654 may also comprise a speaker configured to configured to output audio signals received from the external processing device.

1. A remote control device comprising:
a control unit comprising a first input circuit configured to receive user inputs, a first wireless communication circuit configured to transmit and receive wireless signals via a wireless communication link, and a first control circuit configured to cause the first wireless network communication circuit to transmit messages via the wireless signals in response to the user inputs received via the input circuit, the first control circuit configured to operate in a plurality of operating modes, the first control circuit configured to transmit a first message for controlling a first electrical load when the control unit is operating in a first operating mode of the plurality of operating modes and a second message for controlling a second electrical load when the control unit is operating in a second operating mode of the plurality of operating modes; and
a mounting unit to which the control unit is configured to be mounted, the mounting unit comprising a second input circuit configured to receive user inputs and a second control circuit responsive to the second input circuit of the mounting unit;
wherein, when the control unit is mounted to the mounting unit, the second control circuit of the mounting unit is configured to transmit a third message to the first control circuit of the control unit in response to receiving a user input via the second input circuit, and the first control circuit of the control unit is configured to change between the plurality of operating modes in response to receiving the third message from the second control circuit of the mounting unit.

2. The remote control device of claim 1, wherein the control unit comprises a first battery for powering the first input circuit, the first wireless communication circuit, and the first control circuit.

3. The remote control device of claim 2, wherein the mounting unit comprises an external supply circuit for providing power to the control unit when the control unit is mounted to the mounting unit.

4. The remote control device of claim 3, wherein the control unit comprises a remote charging circuit for charging the battery from the mounting unit.

5. The remote control device of claim 4, wherein the external supply circuit of the mounting unit is magnetically couplable to the remote charge circuit of the control unit via a magnetic coupling for charging the battery from the mounting unit when the control unit is mounted to the mounting unit.

6. The remote control device of claim 4, wherein the first control unit of the control unit is configured to communicate with the second control unit of the mounting unit via the magnetic coupling.

7. The remote control device of claim 2, wherein the mounting unit is configured to be electrically coupled to the control unit for powering the control unit.

8. The remote control device of claim 7, wherein the mounting unit comprises pogo pins configured to contact electrical pads on a printed circuit board of the control unit for electrically connecting the mounting unit to the control unit when the when the control unit is mounted to the mounting unit.

9. The remote control device of claim 7, wherein the control unit comprises electrical contacts configured to contact electrical pads on the mounting unit for electrically connecting the mounting unit to the control unit when the when the control unit is mounted to the mounting unit.

10. The remote control device of claim 7, wherein the control unit comprises a battery compartment for receiving the first battery, and the mounting unit may comprise an electrical coupling member configured to be installed in the battery compartment of the control unit for powering the control unit.

11. The remote control device of claim 2, wherein the mounting unit comprises a second battery having a greater energy capacity that the first battery of the control unit, the external supply circuit configured to provide power from the second battery to the control unit when the control unit is mounted to the mounting unit.

12. The remote control device of claim 11, wherein the mounting unit comprises a power terminal configured to be connected to an external power source and an internal charging circuit configured to charge the second battery from the external power source.

13. The remote control device of claim 1, wherein the first control circuit is configured to determine that the control unit is mounted to the mounting unit and operate in a mounted mode when the control unit is mounted to the mounting unit.

14. The remote control device of claim 13, wherein the mounting unit comprises a magnet, and the control unit comprises a magnetic sensing circuit configured to detect the presence of the magnet, the first control circuit of the control unit configured to operate in the mounted mode in response to detecting the presence of the magnet.

15. The remote control device of claim 13, wherein the mounting unit is configured to transmit wireless signals to the control unit, the first control circuit of the control unit configured to measure a received signal strength magnitude of at least one of the wireless signals and operate in the mounted mode when the received signal strength magnitude of the at least one of the wireless signals exceeds a threshold.

16. The remote control device of claim 13, wherein the control unit comprises an orientation detect circuit, the first control circuit of the control unit configured to determine an orientation of the control unit in response to the orientation detect circuit, the first control circuit of the control unit configured to operate in the mounted mode when the orientation of the control unit is at least one of a vertical orientation or an angled orientation.

17. The remote control device of claim 13, wherein the first control circuit of the control unit configured to operate in the mounted mode when the control unit is electrically connected to the mounting unit.

18. The remote control device of claim 13, wherein the first control circuit is configured to operate in the mounted mode in response to inputs receives via the input circuit during an advanced programming mode.

19. The remote control device of claim 13, wherein the control unit comprises a battery for powering the input circuit, the wireless communication circuit, and the first control circuit, and a remote charging circuit for charging the battery from the mounting unit, the first control circuit of the control unit configured to control the remote charging circuit to charge the battery through the mounting unit when the control unit is operating in the mounted mode.

20. The remote control device of claim 13, wherein the first control circuit of the control unit is configured to determine control information for controlling one or more electrical loads based on whether the control unit is operating in the mounted mode or not, and transmit a fourth message including the control information via the wireless communication circuit.

21. The remote control device of claim 1, wherein the mounting unit comprises a mounting structure configured to be vertically oriented when mounted.

22. The remote control device of claim 21, wherein the first control circuit of the control unit is configured to determine if the control unit is mounted in one of first or second opposing orientations when the control unit is mounted to the mounting structure.

23. The remote control device of claim 22, wherein the control unit comprise a visual display configured to be illuminated to indicate feedback information, the first control circuit of the control unit configured to illuminate the visual display to indicate the feedback information in dependence upon whether the control unit is mounted in the first orientation or the second orientation.

24. The remote control device of claim 23, wherein the control unit may also be mounted to a horizontally-oriented pedestal, the first control circuit of the control unit configured to maintain the determined orientation constant at one of the first orientation or the second orientation when the control unit is mounted to the horizontally-oriented pedestal.

25. The remote control device of claim 23, wherein the control circuit of the control unit is configured to determine a type of mounting unit to which the control unit is mounted.

26. The remote control device of claim 21, wherein the mounting structure is configured to be mounted to a vertical surface.

27. The remote control device of claim 21, wherein the mounting structure is configured to be mounted to a mechanical switch that is mounted to a vertical surface.

28. The remote control device of claim 1, wherein the mounting unit comprises a pedestal configured to rest on a horizontal surface.

29. The remote control device of claim 27, wherein the mounting unit comprises a circular plate and the control unit comprises a rotation portion, the first input circuit of the control unit comprising a rotational position sensing circuit responsive to rotations of the rotation portion.

30. The remote control device of claim 28, wherein the mounting unit comprises a plurality of actuators arranged in an upper portion of the circular plate, the second input circuit of the mounting unit comprising one or more mechanical switches configured to be actuated by the actuators of the mounting unit.

31. The remote control device of claim 29, wherein the mounting unit comprise a mounting tab extending from the circular plate, the control unit configured to be mounted to the mounting tab of the mounting unit.

32. The remote control device of claim 28, wherein the mounting unit comprises a rectangular plate and control unit comprises a rectangular housing and an actuation portion located in an opening of the housing, the first input circuit of the control unit comprising one or more mechanical switches responsive to actuations of the actuation portion.

33. The remote control device of claim 31, wherein the mounting unit comprises a plurality of actuators arranged in an upper portion of the rectangular plate, the second input circuit of the mounting unit comprising one or more mechanical switches configured to be actuated by the actuators of the mounting unit.

34. The remote control device of claim 32, wherein the mounting unit comprise a platform orientated at an angle with respect to the rectangular plate, the control unit configured to be mounted to the platform of the mounting unit.

35. The remote control device of claim 1, wherein the control unit comprises a first short-range communication circuit and the mounting unit comprises a second short-range communication circuit, the first control circuit of the control unit and the second control circuit of the mounting unit configured to communication via the first and second short-range communication circuits.

36. The remote control device of claim 34, wherein the first and second short-range communication circuits are coupled together via one or more electrical connections to allow for communication between the first control circuit of the control unit and the second control circuit of the mounting unit.

37. The remote control device of claim 35, wherein the mounting unit comprises pogo pins configured to contact electrical pads on a printed circuit board of the control unit for electrically connecting the mounting unit to the control unit when the when the control unit is mounted to the mounting unit.

38. The remote control device of claim 35, wherein the first and second short-range communication circuits comprise short-range wireless communication circuits to allow for wireless communication between the first control circuit of the control unit and the second control circuit of the mounting unit.

39. The remote control device of claim 35, wherein the first and second short-range communication circuits are magnetically couplable together to allow for wireless communication between the first control circuit of the control unit and the second control circuit of the mounting unit.

40. The remote control device of claim 1, wherein the mounting unit comprises a temperature sensing circuit configured to measure a temperature in an area around the remote control device, the first control circuit of the control unit configured to transmit a fourth message including the measured temperature via the first wireless communication circuit.

41. The remote control device of claim 39, wherein the pedestal comprises an orientation detection device, the first control circuit of the control unit configure to cease transmitting messages including measured temperatures after determining that the remote control device is moving in response to the orientation detection device.

42. The remote control device of claim 1, wherein the mounting unit comprises an occupancy sensing circuit configured to detect an occupancy or vacancy condition in an area around the remote control device, the first control circuit of the control unit configured to transmit a fourth message indicating the occupancy or vacancy condition via the first wireless communication circuit.

43. The remote control device of claim 1, wherein the mounting unit comprises a nightlight circuit configured to illuminate a portion of a housing of the mounting unit.

44. The remote control device of claim 1, wherein the second input circuit of the mounting unit comprises one or more mechanical switches configured to be actuated by one or more actuators of the mounting unit.

45. The remote control device of claim 1, wherein the control circuit of the control unit is configured to determine a type of mounting unit to which the control unit is mounted.

46. A remote control device comprising:
a control unit comprising a first input circuit configured to receive user inputs, a first wireless communication circuit configured to transmit and receive wireless signals via a wireless communication link, and a first control circuit configured to cause the first wireless network communication circuit to transmit messages via the wireless signals in response to the user inputs received via the input circuit; and
a mounting unit to which the control unit is configured to be mounted, the mounting unit comprising a second input circuit configured to receive user inputs and a second control circuit responsive to the second input circuit of the mounting unit, the second control circuit of the mounting unit is configured to determine a selected preset for controlling one or more electrical loads in response to receiving a user input via the second input circuit and transmit a first message including the selected preset to the first control circuit of the control unit when the control unit is mounted to the mounting unit;
wherein, when the control unit is mounted to the mounting unit, the second control circuit of the mounting unit is configured to determine a selected preset for controlling one or more electrical loads in response to receiving a user input via the second input circuit and transmit a first message including the selected preset to the first control circuit of the control unit, the first control circuit of the control unit is configured to receive the first message from the second control circuit of the mounting unit and transmit a second message including the selected preset via the wireless communication circuit.

47. The remote control device of claim 45, wherein the first control circuit is configured to operate in a plurality of operating modes, the first control circuit configured to transmit a third message for controlling a first electrical load when the control unit is operating in a first operating mode of the plurality of operating modes and a fourth message for controlling a second electrical load when the control unit is operating in a second operating mode of the plurality of operating modes.

48. The remote control device of claim 46, wherein the mounting unit comprises a switch, and the first control circuit of the control unit is configured to change between the plurality of operating modes in response to actuations of the switch.
